(19) United States
(12) Patent Application Publication
(10) Pub. No.: US 2025/0350789 A1
(43) Pub. Date: Nov. 13, 2025

(54) USER INTERFACES FOR CATEGORIZING COMMUNICATION ITEMS

(71) Applicant: Apple Inc., Cupertino, CA (US)

(72) Inventors: Marcos A. WESKAMP, Palo Alto, CA (US); Oluwaseyi A. AMOLE, San Jose, CA (US); Mayura D. DESHPANDE, San Carlos, CA (US); Marcel VAN OS, Santa Cruz, CA (US); Jason ORLOVICH, San Francisco, CA (US); Michael L. LOPP, Los Gatos, CA (US); Ashley B. CLARK, Menlo Park, CA (US); Irene VALDES SALAZAR, Palo Alto, CA (US); Sven P. BACIA, Fremont, CA (US); Genesis GIRALDO, Oakland, CA (US); Ronak N. SHAH, Los Altos, CA (US)

(21) Appl. No.: 19/203,048

(22) Filed: May 8, 2025

Related U.S. Application Data
(60) Provisional application No. 63/646,453, filed on May 13, 2024.
(60) Provisional application No. 63/656,790, filed on Jun. 6, 2024.

(51) Int. Cl. H04N 21/431; H04N 21/433

(52) U.S. Cl. CPC H04N 21/4316; H04N 21/4332

(57) ABSTRACT

In some embodiments, an electronic device receives indications of communication items and categorizes the indications of communication items into a plurality of categories. In some embodiments, the indications of communication items in the first category are further categorized into highlighted representations of indications of communication items and non-highlighted representations of indications of communication items.

### CROSS-REFERENCE TO RELATED APPLICATIONS

This application claims the benefit of U.S. Provisional Application No. 63/656,790, filed Jun. 6, 2024, and U.S. Provisional Application No. 63/646,453, filed May 13, 2024, the contents of which are herein incorporated by reference in their entireties for all purposes.

### FIELD OF THE DISCLOSURE

This disclosure relates generally to an electronic device presenting user interfaces for categorizing communication items.

### BACKGROUND OF THE DISCLOSURE

User interaction with electronic devices has increased significantly in recent years. These devices can be devices such as computers, tablet computers, televisions, multimedia devices, or mobile devices. While presenting communication items using an electronic device, the user may wish to view a user interface with the communication items organized into categories. The user may therefore desire efficient ways of organization communication items and displaying communication items.

### SUMMARY OF THE DISCLOSURE

Providing efficient ways of presenting communication items to a user via an application of an electronic device may improve the user's experience with the electronic device and reduce the number of inputs needed to sort through communication items of varying importance, thereby reducing power usage and improving the battery life of the electronic device.

In some embodiments, an electronic device receives indications of communication items and categorizes the indications of communication items into a plurality of categories. In some embodiments, the indications of communication items in the first category are further categorized into highlighted representations of indication of communication items and non-highlighted representations of indications of communication items.

The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6T illustrate exemplary ways in which an electronic device displays user interfaces in a content application including categorization of indications of communication items in accordance with some embodiments of the disclosure.

FIG. 7 illustrates a flow diagram illustrating a method in which an electronic device displays user interfaces in a content application including categorization of indications of communication items in accordance with some embodiments of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used and structural changes are optionally made without departing from the scope of the disclosed embodiments.

Providing efficient ways of presenting communication items to a user via an application of an electronic device may improve the user's experience with the electronic device and reduce the number of inputs needed to sort through communication items of varying importance, thereby reducing power usage and improving the battery life of the electronic device. In some embodiments, an electronic device receives indications of communication items and categorizes the indications of communication items into a plurality of categories. In some embodiments, the indications of communication items in the first category are further categorized into highlighted representations of indication of communication items and non-highlighted representations of indication of communication items.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### EXEMPLARY DEVICES

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted device (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

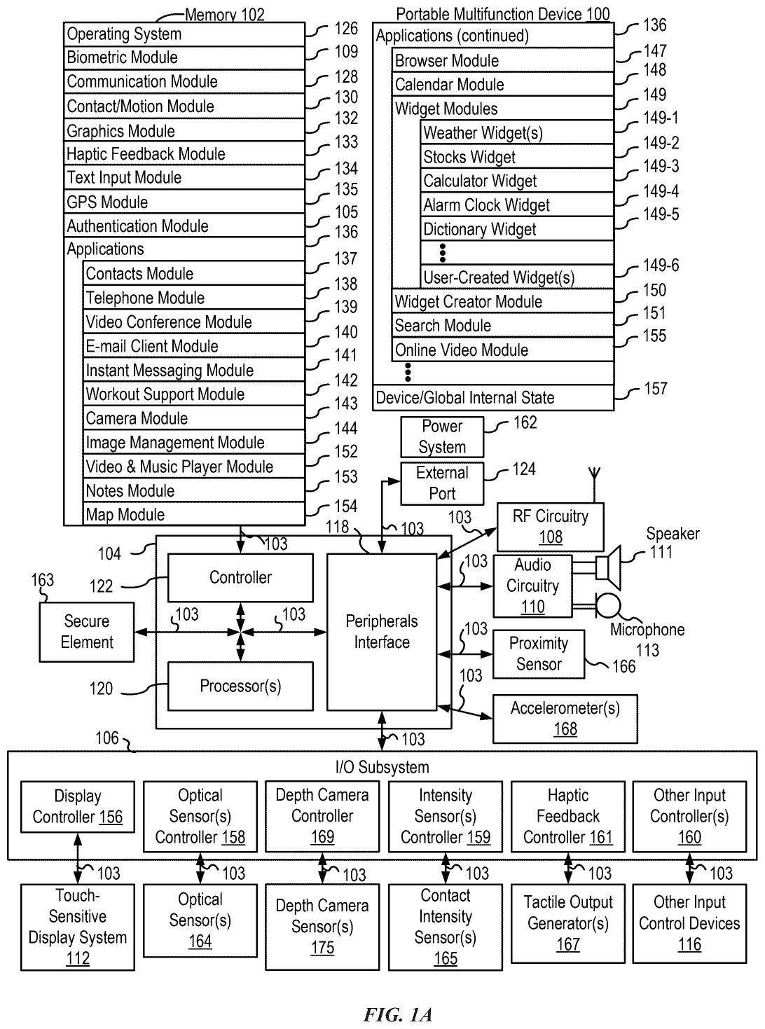

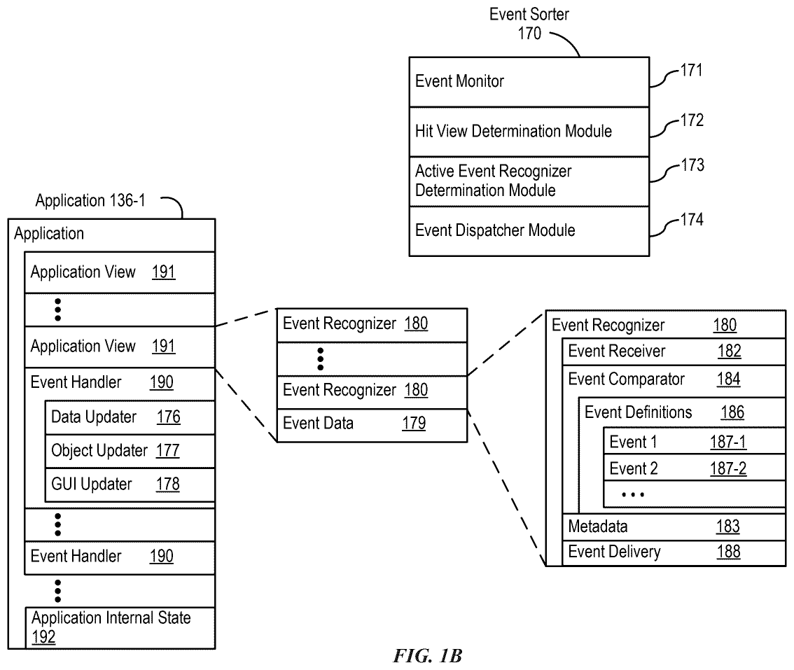

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio.

The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

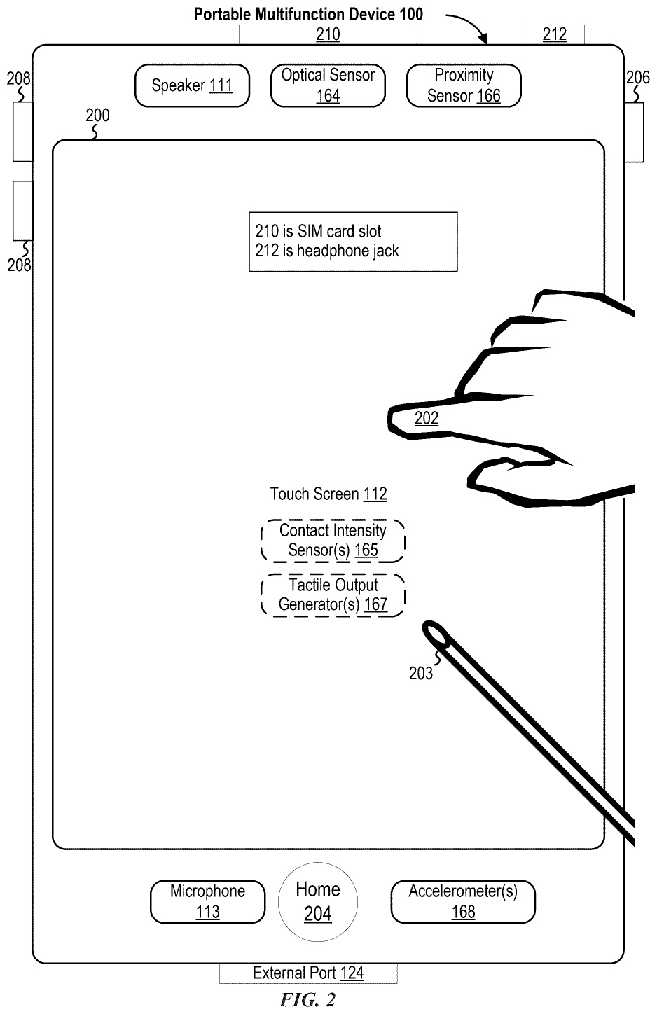

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (A C)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CM OS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

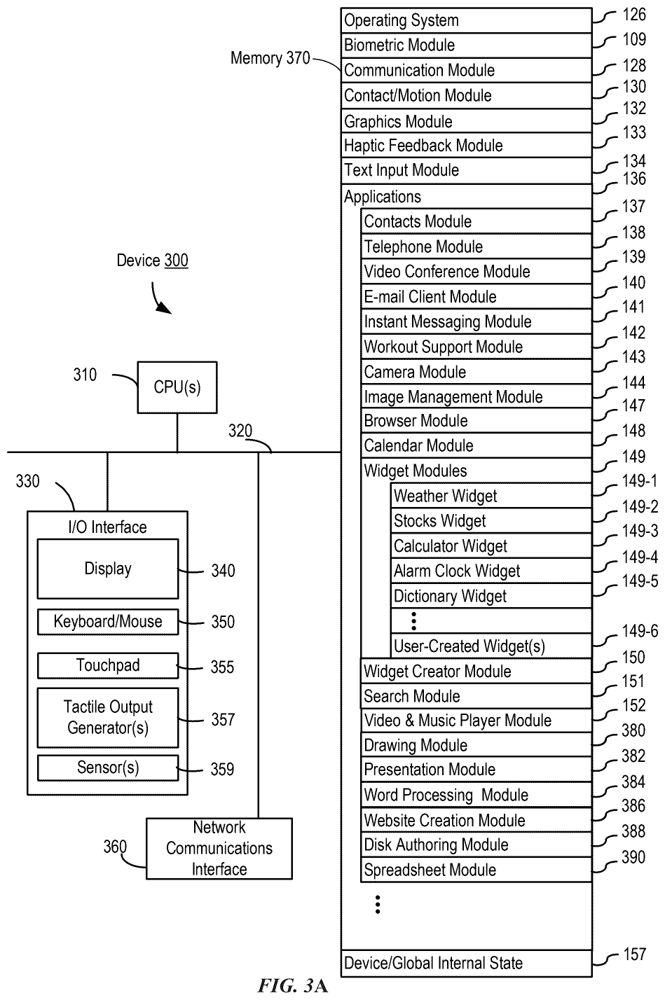

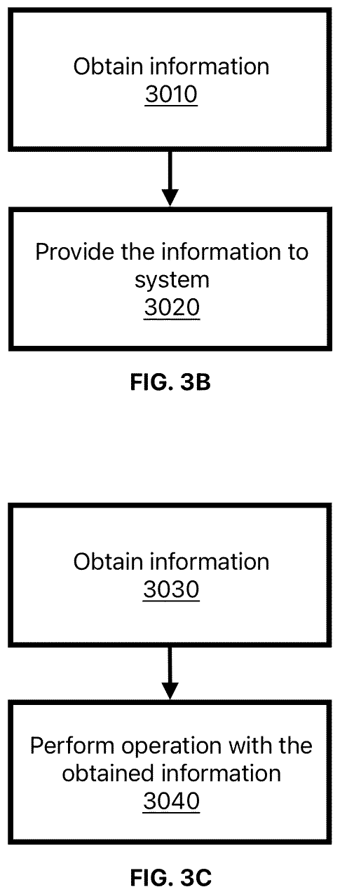

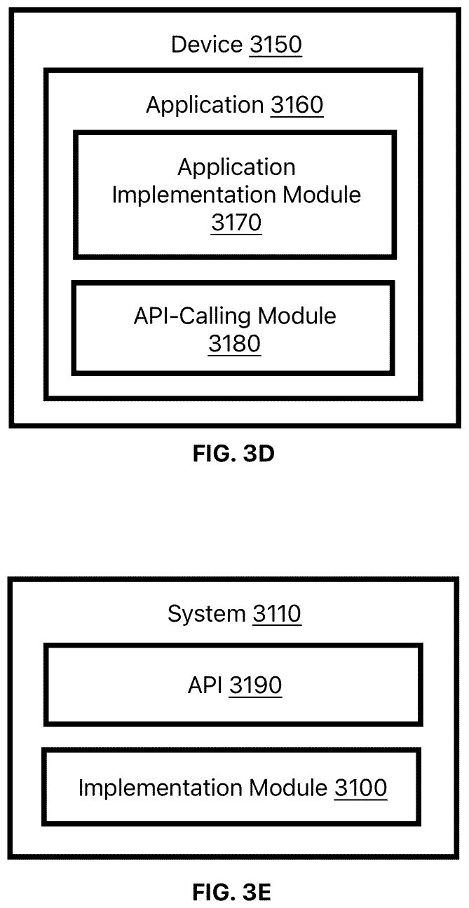

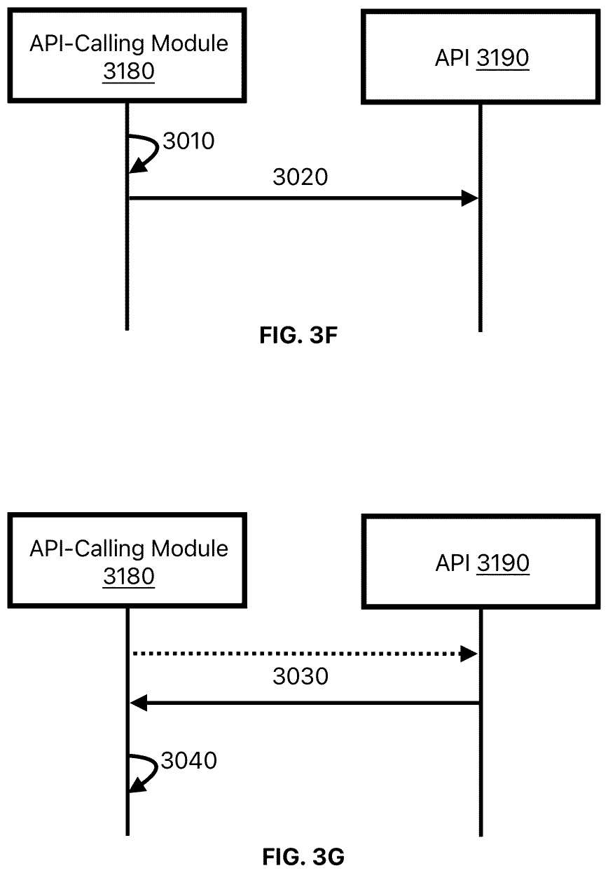

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A-3G) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, instant messaging (IM) module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or instant messaging (IM) module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP 3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIK it API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IM U (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

M any software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

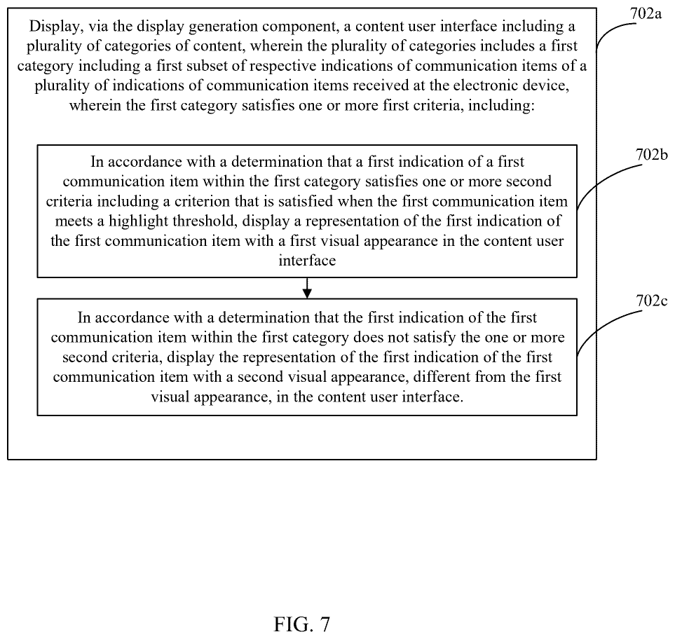

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIK it API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

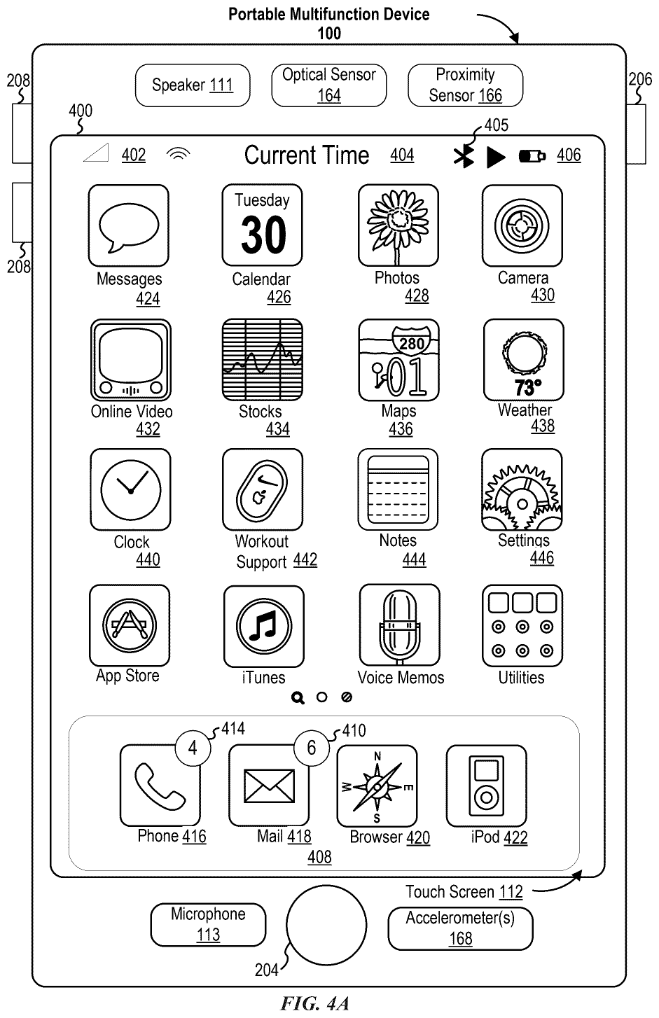

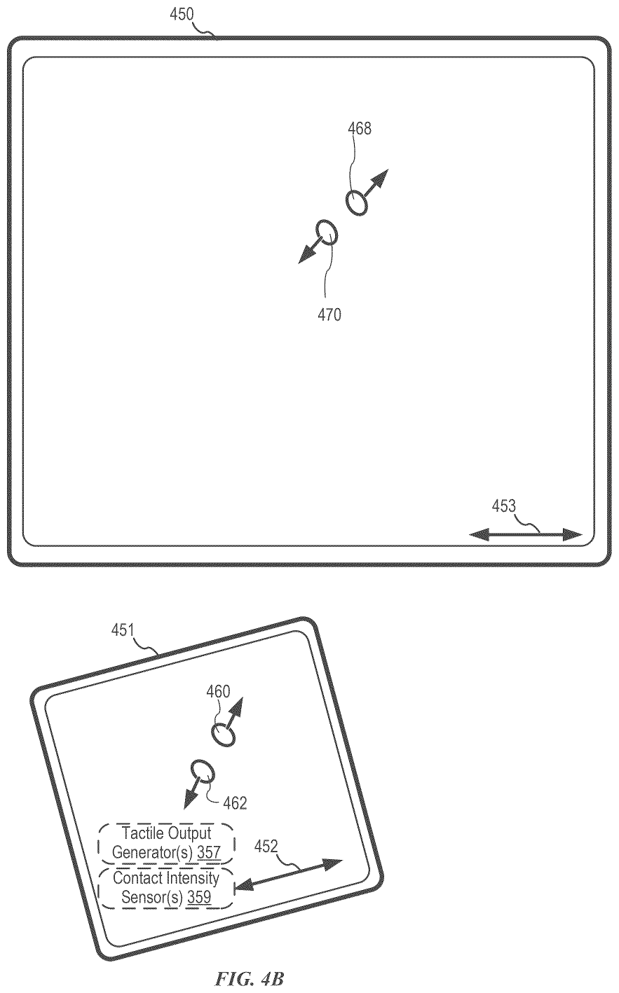

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

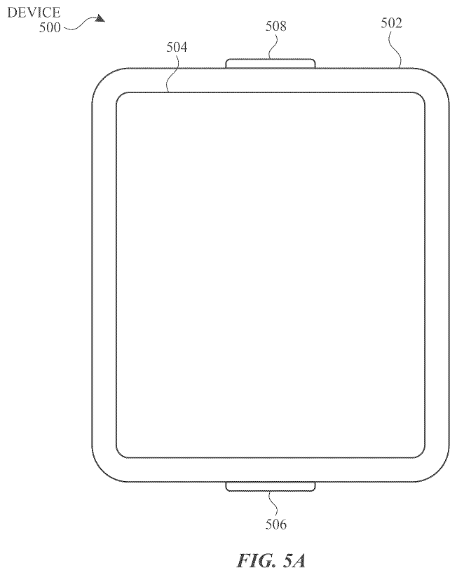

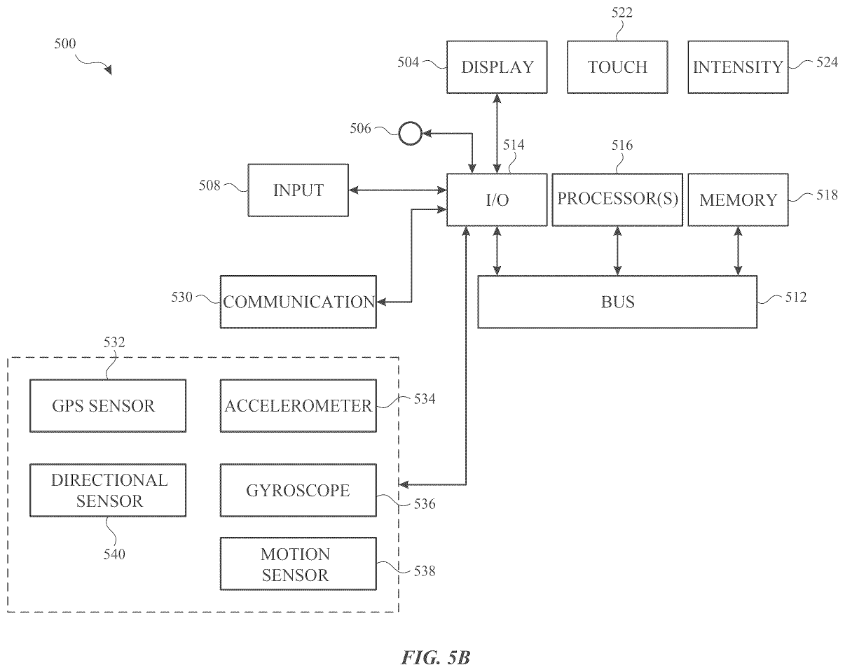

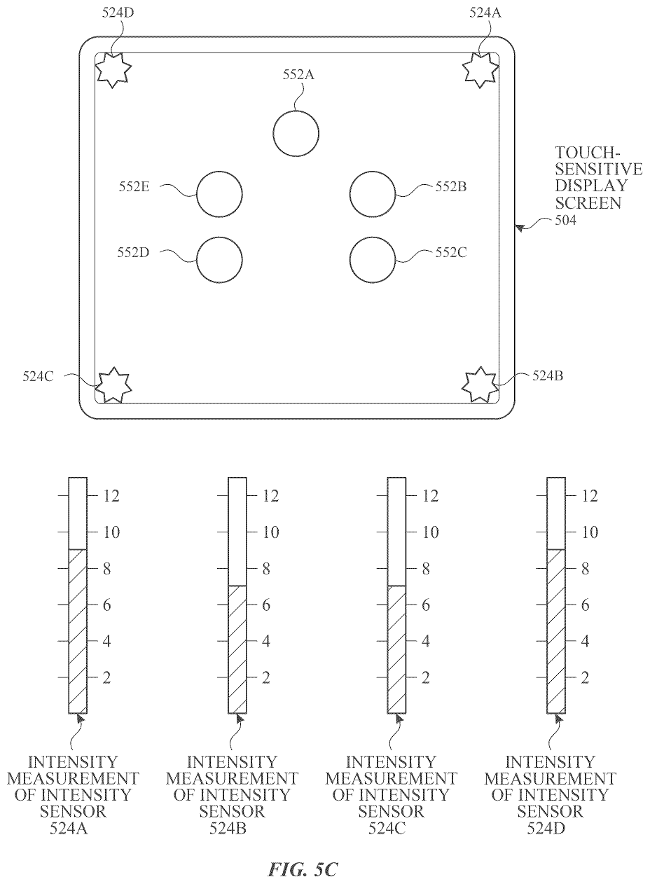

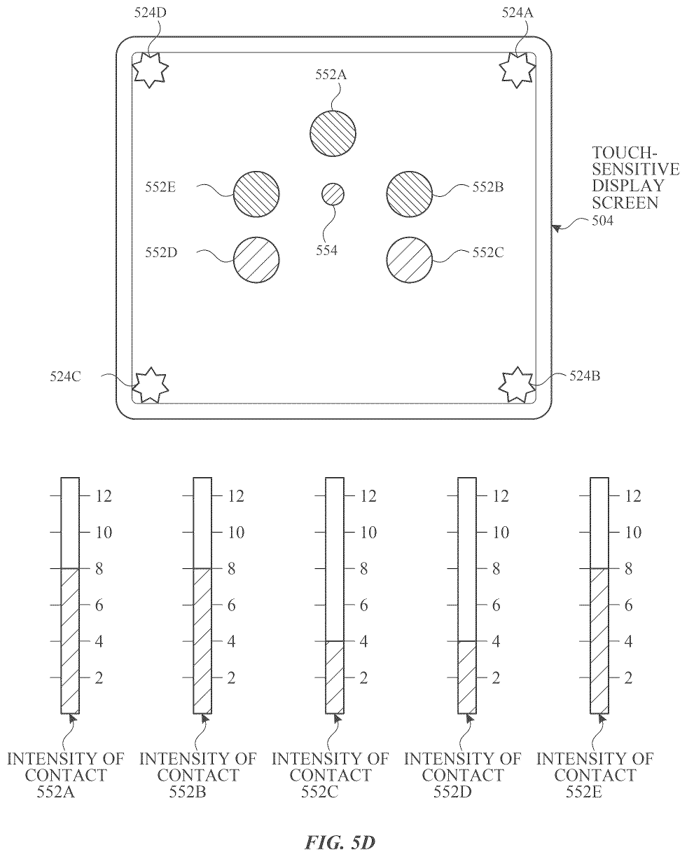

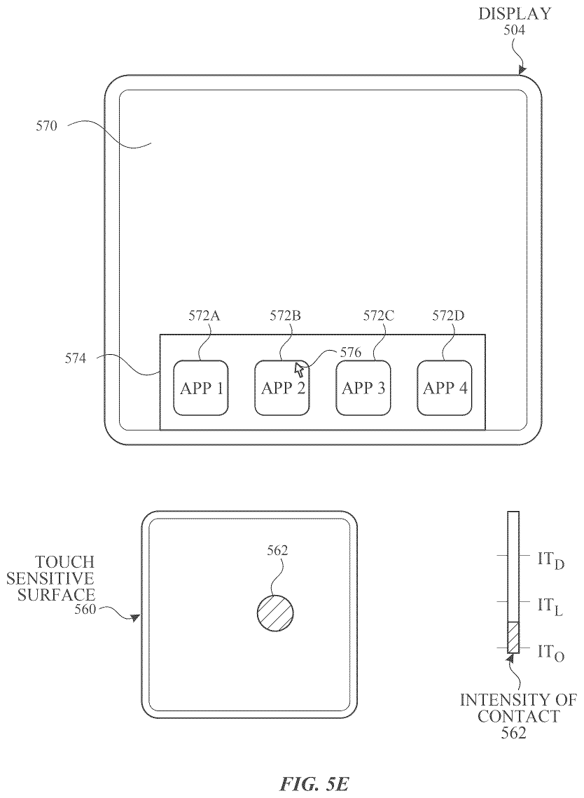

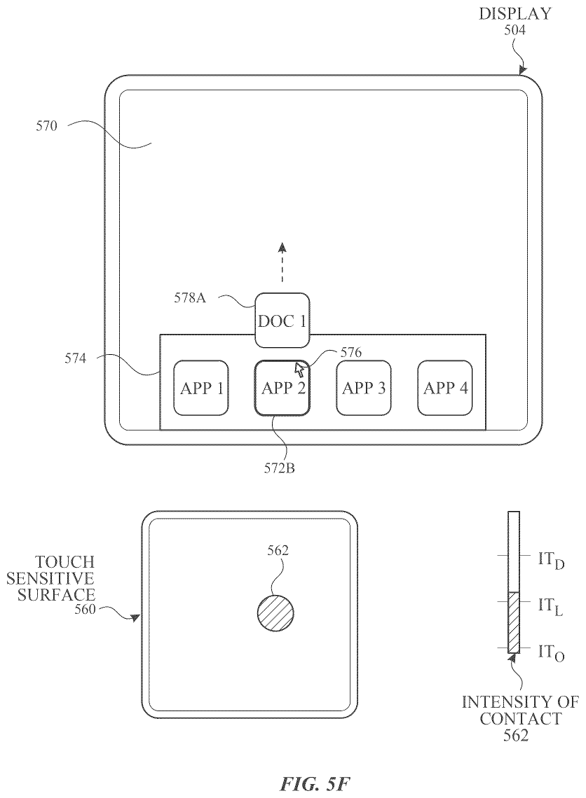

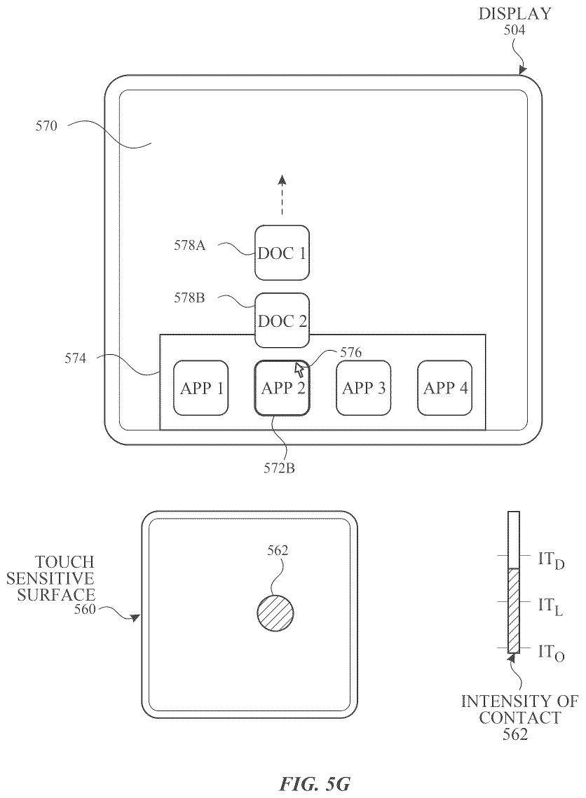

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 504 optionally execute any number of programs stored in memory 506 or storage, which optionally includes instructions to perform one or more of the methods and/or processes described herein (e.g., methods 700). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and EDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “ITL”) in FIG. 5E, to an intensity above a deep press intensity threshold (e.g., “ITD”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “ITD”). Contact 562 is maintained on touch-sensitive surface 560. In response to the detection of the gesture, and in accordance with contact 562 having an intensity that goes above the deep press intensity threshold (e.g., “ITD”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “ITD”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

### User Interfaces and Associated Processes for Categorization of Communication Items

Users interact with electronic devices in many different manners. In some embodiments, an electronic device is in communication with one or more input devices, a display generation component, and wireless circuitry. In some embodiments, the electronic device categorizes communication items of a collection of communication items by the content of the communication items. In some embodiments, the electronic device receives one or more indications of communication items, such as emails or other messages. In some embodiments, the electronic device identifies important indications of communication items (e.g., communication items that satisfy one or more second criteria as described in method 700) and displays representations of the indications of communication items that are important differently than other representations of indications of communication items that are not important. The embodiments described below provide ways that different categories of indications of communication items are displayed. Displaying communication items that satisfy the one or more second criteria with a different visual appearance than communication items that don't satisfy the one or more second criteria enhance user interactions with the electronic device by reducing the number of inputs needed to identify important communication items, and also reduces erroneous inputs to the electronic device. It is understood that people use devices. When a person uses a device, that person is optionally referred to as a user of the device.

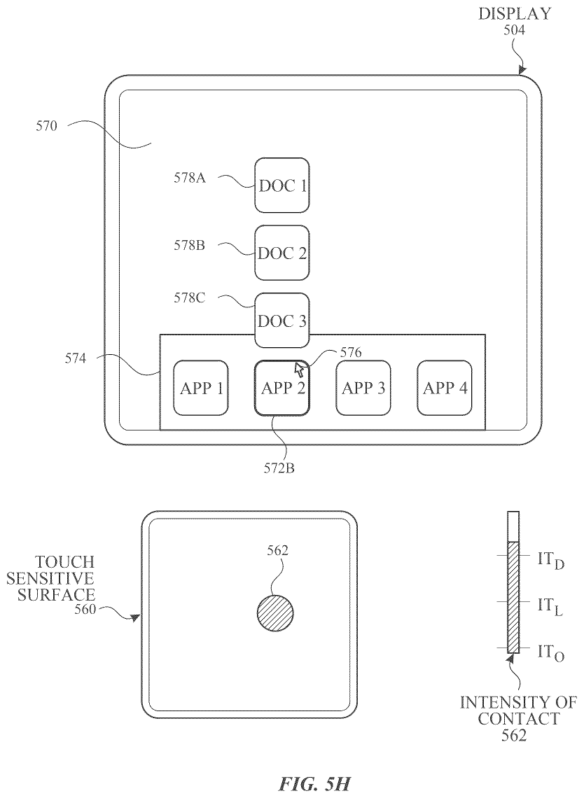

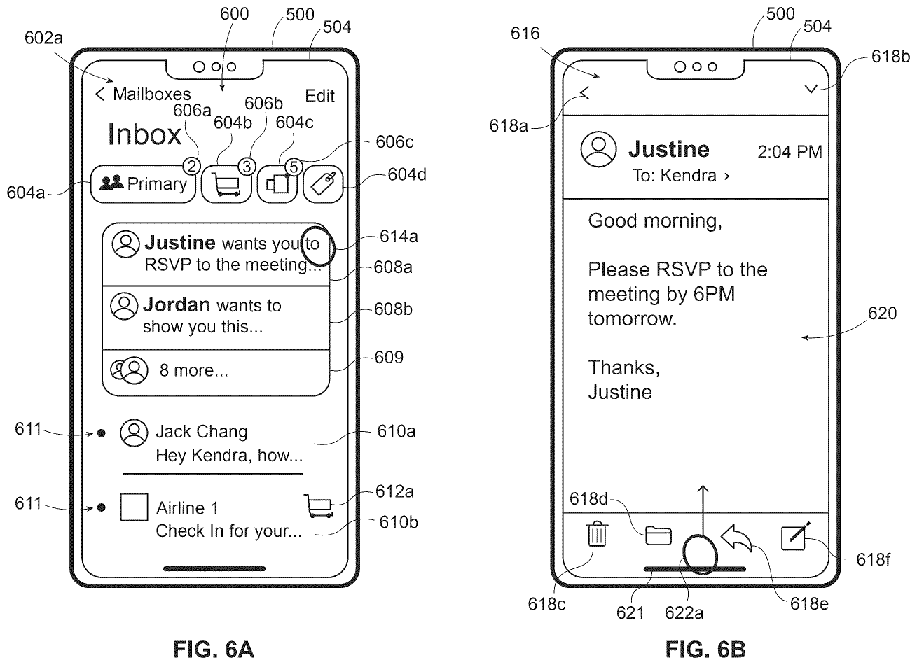

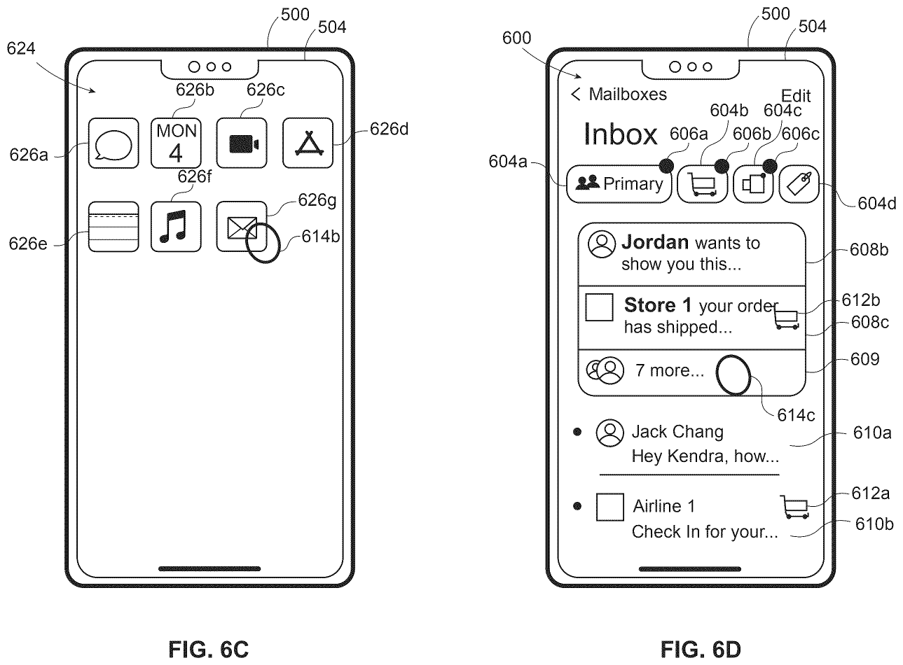

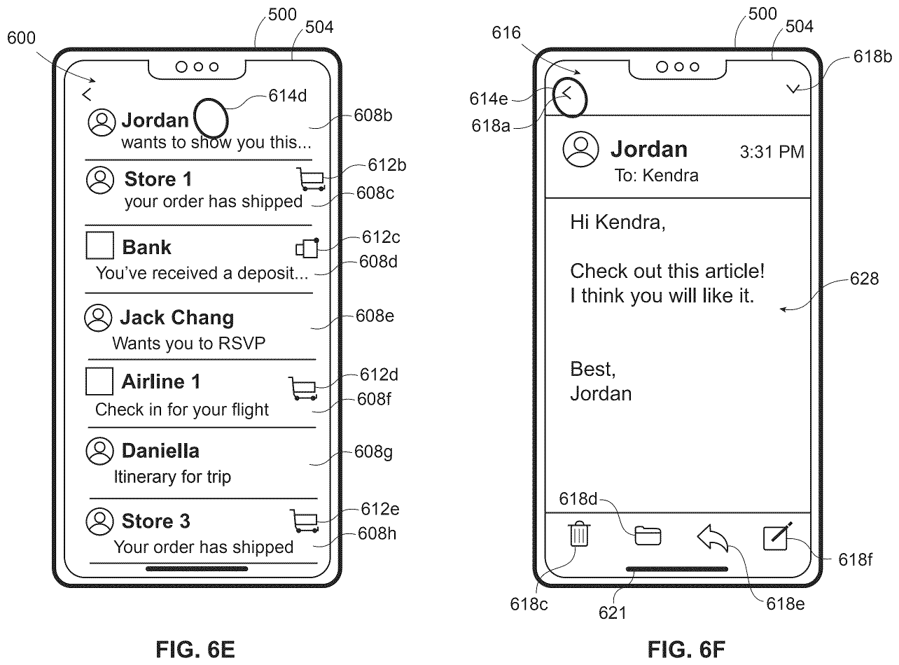

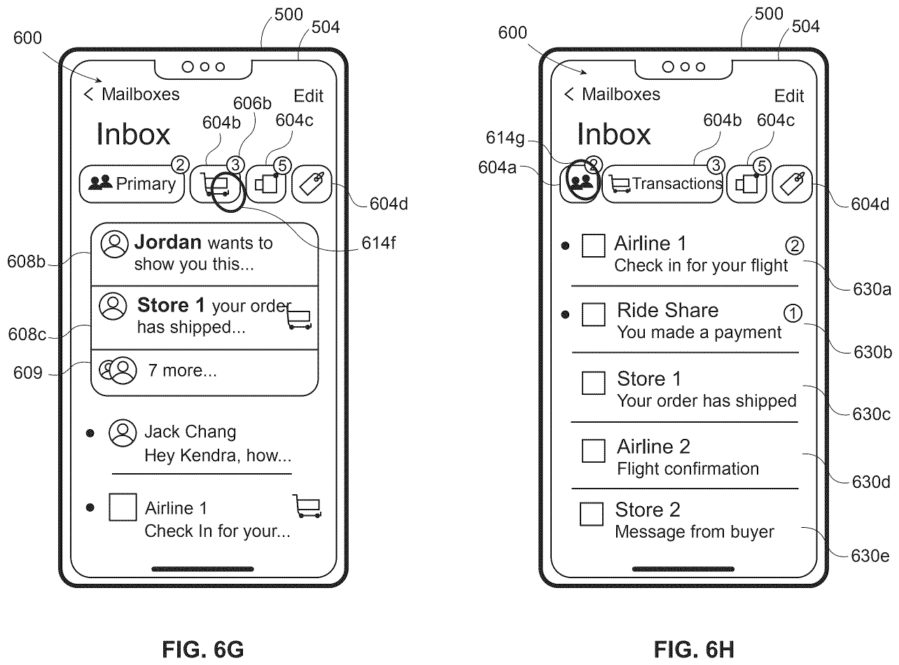

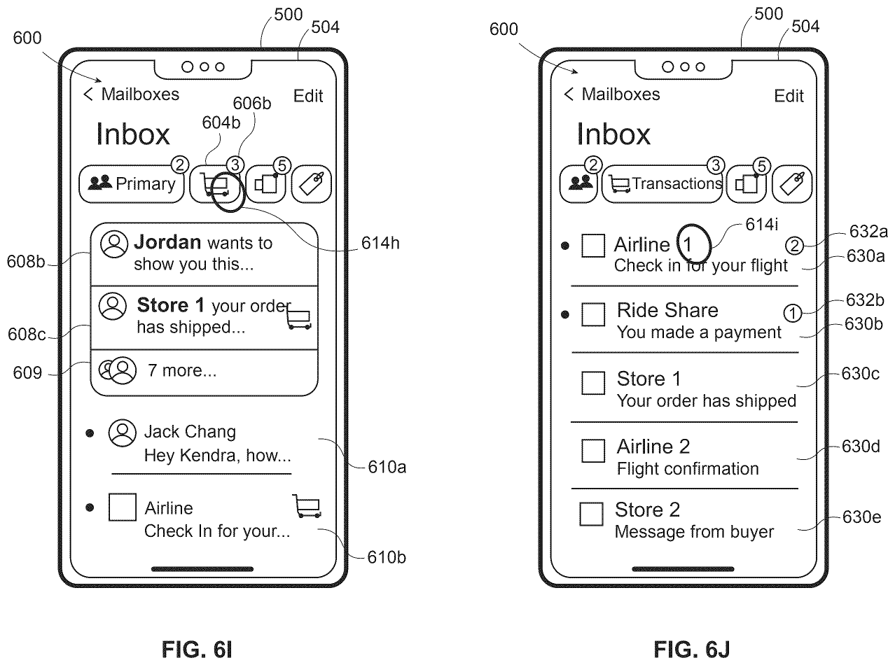

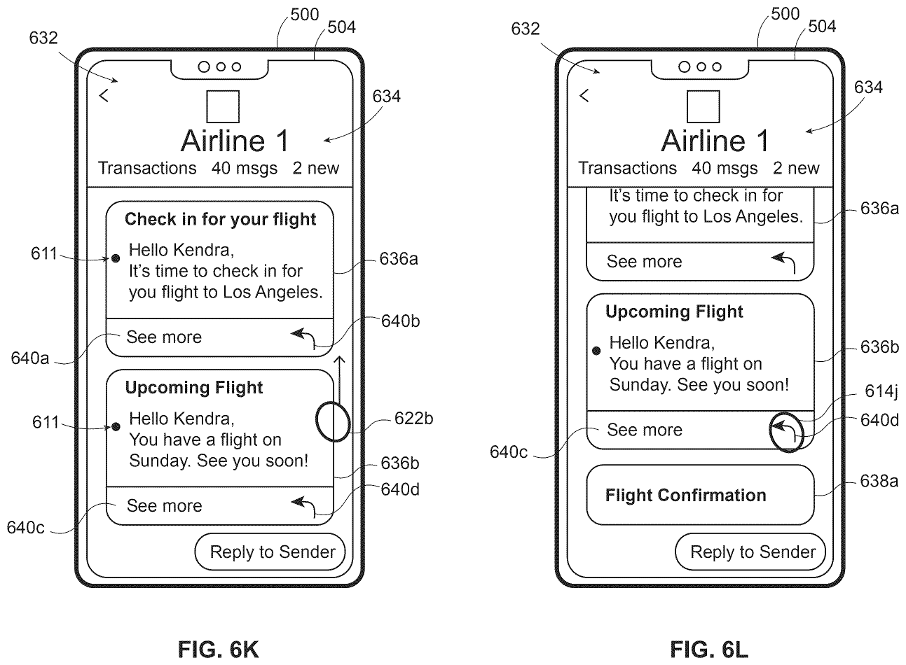

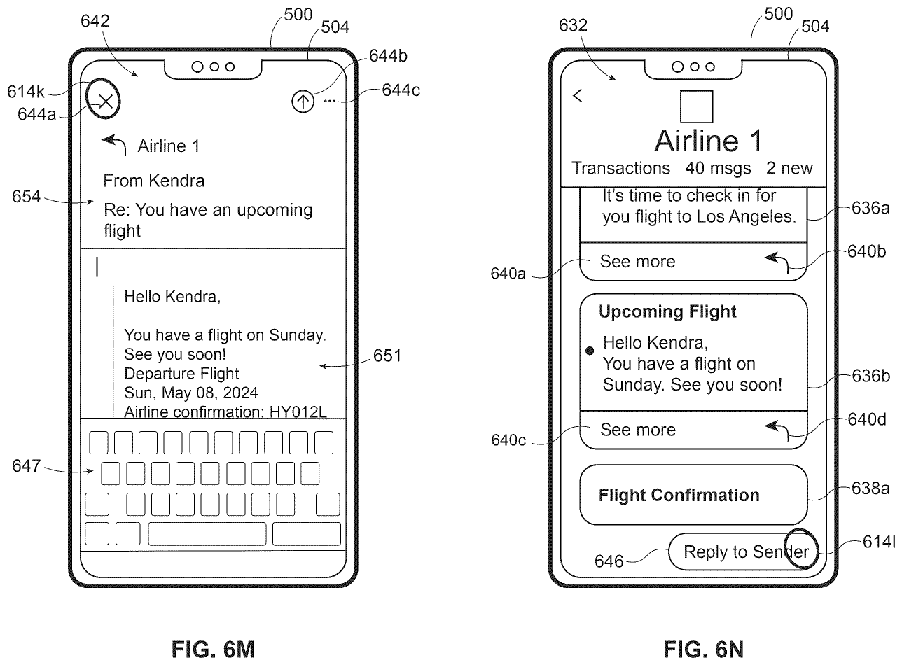

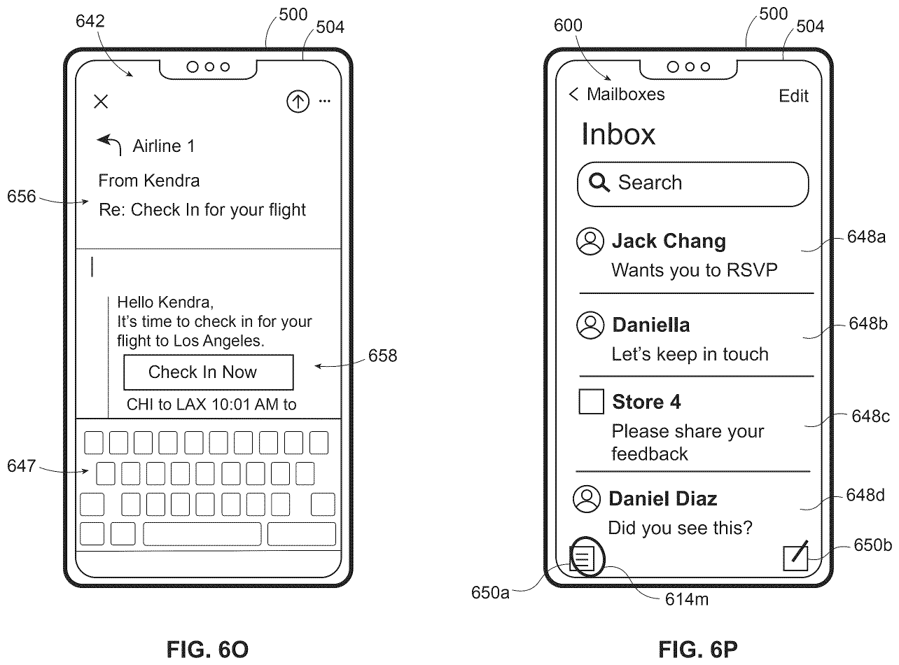

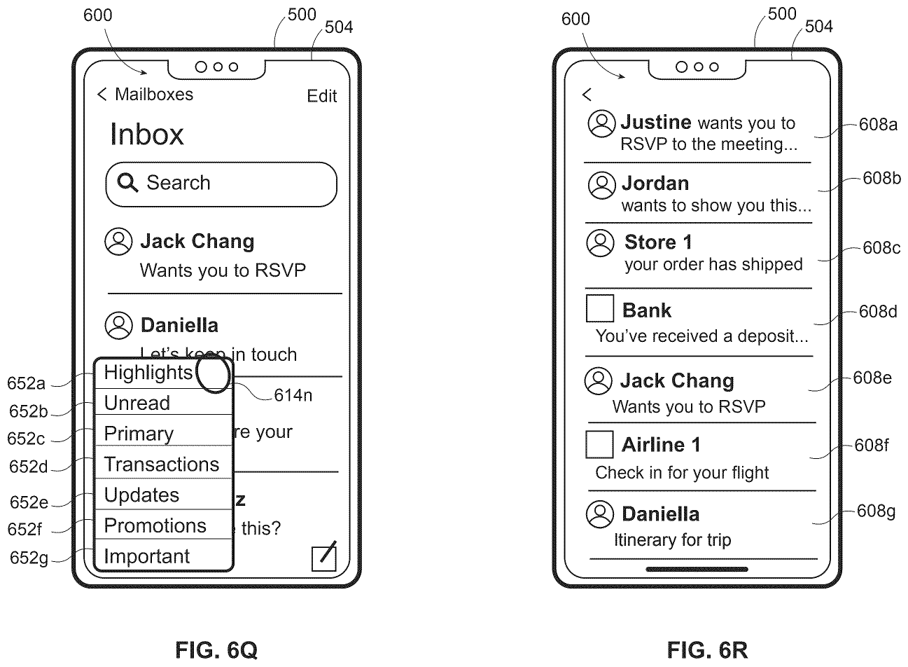

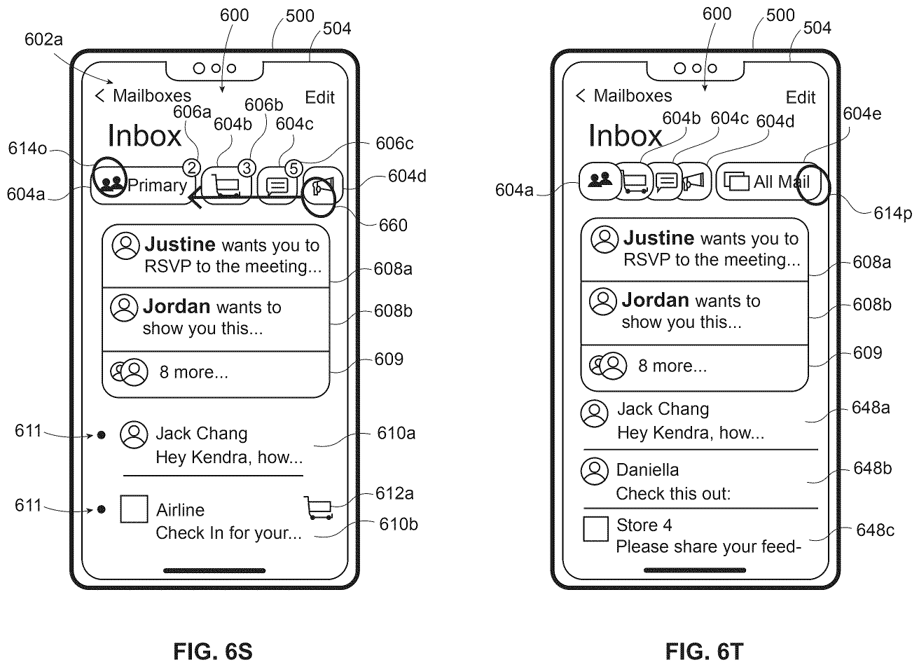

FIGS. 6A-6T illustrate exemplary ways in which an electronic device displays user interfaces in a content application including categorization of indications of communication items. The embodiments in these figures are used to illustrate the processes described below, including the processes described with reference to FIG. 7. Although FIGS. 6A-6T illustrate various examples of ways an electronic device is able to perform the processes described below with respect to FIG. 7, it should be understood that these examples are not meant to be limiting, and the electronic device is able to perform one or more processes described below with reference to FIG. 7 in ways not expressly described with reference to FIGS. 6A-6T.

FIGS. 6A-6D illustrates an embodiments where the electronic device displays a representation of a highlighted communication item and then ceases displaying the representation of the highlighted communication item. FIG. 6A illustrates an electronic device 500 with a display generation component 504 (e.g., a touchscreen). In some embodiments, the electronic device 500 is a mobile device, such as a smartphone, tablet, or wearable device. In FIG. 6A, the electronic device 500 displays user interface 600, a user interface including representations of communication items of a content application. In some embodiments, user interface 600 is a user interface of a content storage application. For example, the content storage application is a mail application, a files application, a web browser application and/or a notes application, or any other application that includes or can store content and/or via which content is accessible. In some embodiments, the content storage application is an application installed on device 500.

In FIG. 6A, the electronic device displays an inbox in user interface 600 (e.g., including representations of communication items received by a first user account associated with a user of the electronic device 500 from one or more second user accounts (optionally not associated with the user of the electronic device 500)). The user interface 600 includes selectable options 602a and 602b in the user interface 600. Selectable option 602a, when selected, causes the electronic device 500 to display a second user interface of the content application including a list of categories of different types of communication items (e.g., sent communication items (sent from a first user account associated with the electronic device), favorited communication items, deleted communication items, and/or draft communication items). In some embodiments, the second user interface also includes an option to display representations of communication items associated with a second user account of the electronic device (e.g., a second email address of the user). Selectable option 602b, when selected, causes the electronic device 500 to display selectable options to move and/or delete representations of communication items currently displayed on user interface 600 in FIG. 6A. In FIG. 6A, the user interface 600 includes selectable options 604a through 604d, which represent the categories that the communication items in the current inbox is sorted by (e.g., primary, transactions, updates, and promotions, respectively). The selectable options 604a through 604d, when selected, causes the electronic device 500 to display representations of communication items within the respective category. In FIG. 6A, the selectable option 604a is expanded (e.g., the text “Primary” is displayed) to indicate that the presently displayed category is the “primary” category. Additionally, the electronic device displays indication 606a concurrently with selectable option 604a, indication 606b concurrently with selectable option 604b, and indication 606c concurrently with selectable option 604c. Indications 606a through 606c illustrate the number of unopened communication items (e.g., communication items in which the electronic device has not displayed the contents of) within the respective categories.

In the “Primary” category in FIG. 6A, the electronic device 500 displays representations 608a through 608b that are representations of highlighted communication items (e.g., communication items that satisfy the one or more second criteria as described in method 700). Representations 608a through 608b include an indication of the sender of the communication item (e.g., text such as a name and/or visual indications such as an icon) a description (e.g., text description) of the contents of the respective communication item. In some embodiments, and as described in method 700, the description is a summary of the contents of the respective communication item and not a direct display of content from the respective communication item. Because representations 608a and 608b are highlighted communication items, they are displayed before the other communication items (e.g., representation 610a and 610b) in the user interface. In some embodiments, highlighted communication items are displayed with priority, as described in method 700. FIG. 6A also includes option 609, which when selected, causes the electronic device 500 to display additional representation of highlighted communication items, as described in FIGS. 6D and 6E.

In FIG. 6A, the electronic device also displays representations 610a and 610b, which are representations of communication items that have been categorized as “Primary” (e.g., that satisfy the one or more first criteria, as described in method 700). In some embodiments, representations 610a and 610b optionally have a corresponding representation in the highlighted communication items, as described in method 700. In some embodiments, the communication items categorized as “Primary” in the user interface 600 are scrollable to reveal additional and/or alternative representations of communication items in the user interface 600. For example, in response to a swipe input directed towards user interface 600, the electronic device 500 displays additional representations of communication items that have been categorized as “Primary”. Representation 610b includes an indication 612a overlaid on the representation 610b. Indication 612a indicates that the representation 610b of the communication item is also found in a different category (e.g., transactions) in user interface 600. For example, indication 612a includes an icon that corresponds to the icon located on option 604b, therefore a representation of the communication item represented by representation 610b is also displayed when the option 604b is selected. Additionally, both representations 610a and 610b include indication 611, which indicates that the electronic device 500 has not displayed the contents of the respective communication items (e.g., the respective communication items are unread). Alternatively, in some embodiments, the electronic device 500 includes indication 611 on representations 610a and/or 610b if the electronic device receives an input corresponding to a request to display the indication 611 on the respective representations (e.g., the user wants to mark communication items individually as unread).

In FIG. 6A, the electronic device 500 receives an input including contact 614a (e.g., a touch input using a finger) directed towards representation 608a. Although touch inputs including contacts are used in the embodiments described here as example inputs, other inputs are possible, including voice, hardware input device inputs, and/or air gesture inputs. In response to receiving the input directed towards representation 608a, the electronic device 500 ceases displaying user interface 600 and displays user interface 616, as shown in FIG. 6B.

FIG. 6B illustrates the user interface 616 of the content application. The user interface 616 is a content user interface including content 620 corresponding to the representation 608a of the communication item shown in FIG. 6A. As described in method 700, the text displayed in representation 608a is not a direct copy of the content 620 displayed in user interface 616 shown in FIG. 6B (e.g., the text displayed in representation 608a is a summary of content 620). User interface 616 includes selectable options 618a through 618g. Selectable option 618a, when selected, causes the electronic device 500 to redisplay user interface 600. Selectable option 618b, when selected, causes the electronic device 500 to display content from a second communication item (e.g., the communication item corresponding to representation 608b in FIG. 6A). Selectable option 618c, when selected, causes the electronic device 500 to delete the indication of the communication item (e.g., such as representation 608a is no longer displayed). Selectable option 618d, when selected, causes the electronic device 500 to display a menu including the categories of communication items such that a user can reassign the communication item to a different category. Selectable option 618e, when selected, causes the electronic device 500 to display a reply user interface including a content entry field where the user can reply to the communication item (e.g., by entering text). In some embodiments, the reply user interface is described in FIG. 6M. Selectable option 618f, when selected, causes the electronic device 500 to display a new communication item user interface wherein the user can add content to be sent as a new communication item to a specified user account.

While displaying the user interface 616, the electronic device 500 also displays bar 621. In FIG. 6B, the electronic device 500 detects a swipe input including contact 622a (e.g., a drag motion using a finger in contact with the touch screen) directed towards bar 621. In response to receiving the input including contact 622a, the electronic device 500 begins displaying a home screen user interface 624, as shown in FIG. 6C and described in greater detail in method 700. The home screen user interface 624 includes selectable options 626a through 626g (e.g., icons) that correspond to different applications. The selectable options 626a through 626g, when selected, causes the electronic device to open a user interface of the respective application. For example, selectable option 626a, when selected, causes the electronic device to display a messaging user interface of the messaging application. In FIG. 6C, the electronic device receives a selection input including contact 614b directed towards selectable option 626g (e.g., which represents the content application). In response to receiving the input, the electronic device 500 redisplays user interface 600, as shown in FIG. 6D.

In FIG. 6D, the electronic device 500 updates user interface 600 to no longer display the representation 608a, and instead display representations 608b and 608c. Additionally, selectable option 609 is optionally updated to include text that says “7 more” instead of “8 more” since the representation 608a is no longer displayed (e.g., indicating that the number of highlighted communication items has decreased by one). As described above, the electronic device 500 no longer displays representation 608a since the electronic device 500 had previously displayed the contents 620 of the communication item of representation 608a and the electronic device 500 also received inputs corresponding to closing the content application and displaying a different user interface of a different application (e.g., the home screen user interface 624 in FIG. 6C), and then reopening the content application including user interface 600. Causing the electronic device 500 to no longer display representation 608a (e.g., a representation of a highlighted communication item) is described in greater detail in method 700. Additionally, in FIG. 6D, the electronic device 500 displays representation 608c of a highlighted communication item. Representation 608c includes indication 612b, which indicates that the representation 608c is also displayed in the transactions category, as a different representation. For example, representation 608c is displayed as representation 630c in the transactions category, shown in FIG. 6H. In some embodiments, communication items that are categorized in other categories other than the primary category (e.g., transactions, updates, promotions categories) are able to be displayed in the highlights sections (e.g., the section including representations 608b and 608c in FIG. 6D), if they satisfy one or more criteria, described in greater detail in method 700. In some embodiments, the one or more criteria include an urgency criteria, a travel criteria and/or a recency criteria. In some embodiments, the electronic device uses artificial intelligence and/or machine learning to determine whether a communication item meets the one or more criteria.

FIG. 6D also includes an alternative embodiment of indications 606a through 606c. In FIG. 6D, the indications 606a through 606c do not show the number of unread communication items, as shown in FIG. 6A. In FIG. 6D, the electronic device 500 receives a selection input including contact 614c directed towards option 609 to display additional representations of highlighted communication items. In response to receiving the input including contact 614c, the electronic device 500 displays additional representations of highlighted communication items including representations 608b through 608h (e.g., representations 608b and 608c were previously displayed in FIG. 6D), as shown in FIG. 6E. In some embodiments, the additional representations (e.g., representations 608d though 608h) include one or more characteristics of representations 608a through 608b described with reference to FIG. 6A.

FIG. 6E illustrates additional representations of highlighted communication items including representations 608b through 608h. Representations 608c, 608f, and 608h include indications 612b, 612d, and 612e, respectively, to indicate that the communication items represented by representations 608c, 608f, and 608h are also displayed as representations of communication items that are not highlighted in the transactions category, displayed in FIG. 6H. Representation 608d in FIG. 6E includes representation 612c which includes an icon corresponding to the icon on option 604c, shown in FIG. 6D. This indicates that representation 608d is also found as a representation of a communication item that is not highlighted in the third category (e.g., the updates category).

In FIG. 6E, the electronic device 500 receives a selection input including contact 614d directed towards representation 608b. In response to receiving the input including contact 614d, the electronic device 500 display user interface 616 including content 628 corresponding to the representation 608b of a second communication item, as shown in FIG. 6F.

FIGS. 6F-6I illustrate an embodiment wherein the electronic device 500 displays the representation of a highlighted communication item and continues to display the representation of the highlighted communication item despite receiving inputs to display other user interface and/or other categories of communication items. In FIG. 6F, the electronic device 500 receives a selection input including contact 614e directed towards option 618a.

In response to receiving the input including contact 614e, the electronic device 500 ceases displaying user interface 616 and redisplays user interface 600, as shown in FIG. 6G. In FIG. 6G, the electronic device 500 continues to display representation 608b. In FIG. 6G, the electronic device 500 receives a selection input including contact 614f directed towards option 604b to display representations of communication items in a second category (e.g., “transactions”), as shown in FIG. 6H.

FIG. 6H illustrates the user interface 600 including the display of representations of communication items 630a through 630e in the second category, “transactions”. The representations of communication items 630a through 630e are described in FIG. 6J. In FIG. 6H, the electronic device 500 no longer displays the text, “Primary”, on option 604a and displays the text “Transactions”, on option 604b because the electronic device 500 is displaying the representations of communication items of the transactions category and is no longer displaying the representations of communication items of the primary category. In FIG. 6H, the electronic device 500 receives a selection input including contact 614g directed to option 604a. In response to receiving the input including contact 614g, the electronic device 500 redisplays the representations of highlighted communication items and representations of communication items in the primary category, as shown in FIG. 6I.

In FIG. 6I, the electronic device 500 continues displaying representation 608b of the highlighted communication item sent from a user account associated with “Jordan”. As described in method 700, because the electronic device 500 did not receive an input to navigate to a different application and/or to the home screen after displaying the content 628 of the communication item associated with “Jordan”, then the electronic device 500 continues to display the representation 608b of the highlighted communication item. In some embodiments, this flow to display or to not display representations of communication items is directed towards representations of highlighted communication items. For example, if the electronic device 500 displays the content of representation 610b (shown in FIG. 6I) in user interface 616, which is not a highlighted communication item, then the electronic device 500 would cease displaying the representation 610b after redisplaying user interface 600. This also applies to representations of communication items in other categories (e.g., representations 630a through 630e) that are not displayed as a highlighted communication item. For example, representations of communication items (e.g., representations 630a through 630e) are no longer displayed after the electronic device 500 displays the contents of the respective communication items.

In FIG. 6I, the electronic device 500 receives a selection input including contact 614h directed towards option 604b. In response to receiving the input including contact 614h the electronic device displays the representations 630a through 630e of communication items associated with the second category (e.g., the transactions category), as shown in FIG. 6J.

FIG. 6J illustrates representations 630a through 630e of communication items associated with the second category. In some embodiments, the electronic device 500 does not display representations of highlighted communication items in categories associated with options 604b through 604d. In the categories associated with options 604b through 604d, the electronic device 500 displays the representations of communication items in a conversation view (e.g., messages from a specific sender are grouped together. For example, in FIG. 6J, the electronic device displays representations 630a, which when selected causes the electronic device 500 to display the messages associated with “airline”, shown in FIGS. 6K-6L. When the electronic device 500 detects an input directed towards one of representations 630a through 630e, the electronic device 500 displays a respective user interface including the messages associated with the respective senders (e.g., “airline 1”, “ride share”, “store 1”, “airline 2”, and “store 2” respectively). Representations 630a through 630e include respective indications of the sender of the communication items and a visual indication of the sender (e.g., a logo associated with the airline 1, ride share, store 1, airline 2, and store 2) on the respective representations 630a through 630e. Additionally, representations 630a includes indication 632a and indication 611. Both indication 632a and 611 indicate that there are communication items associated with the sender, “airline 1”, that the electronic device 500 has not yet displayed the contents of (e.g., that are marked as unread). Indication 632a indicates that there are two communication items that are marked as unread. Indication 611 has one or more characteristics of indication 611 as described in FIG. 6A. In some embodiments, the electronic device 500 displays either indication 632a or indication 611 or both. Additionally, representations 630b includes indication 632b and indication 611. Indication 632b has one or more characteristics of indication 632a, as described above. Indication 611 has one or more characteristics of indication 611 as described in FIG. 6A. Indication 632b indicates that there is one unread communication item associated with the sender “ride share”. The sum of the numbers displayed on indications 632a and 632b add to the number displayed on indication 606b (e.g., 2+1=3). In some embodiments, the user interface 600, as described above, is scrollable to display additional representations of communication items. Additionally, representations 630a and 630c correspond to representations 608c and 608f, respectively, in the highlighted communication items. In some embodiments, representations 630a and 630c represent communication items that satisfy the one or more criteria, described in greater detail in method 700, such that they are displayed as highlighted communication items as well as transaction communication items.

In FIG. 6J, the electronic device 500 receives a selection input including contact 614i, directed towards representation 630a. In response to receiving the input including contact 614i, the electronic device 500 displays user interface 632, as shown in FIG. 6K.

FIG. 6K illustrates user interface 632, which includes a display of the representations of communication items associated with the sender, “airline 1”. The conversation view is described in greater detail in method 700. The user interface 632 includes a header 634 including information about the communication items associated with the sender. The header 634 includes a name and visual representation associated with the sender (e.g., “airline 1”), the category associated with the sender (e.g., transactions), a number of total messages from the sender (e.g., 40 messages), and a number of unread messages from the sender (e.g., 2 messages). In some embodiments, the visual representation associated with the sender corresponds to the visual representation displayed with representation 620a in FIG. 6L. In user interface 632, the electronic device 500 displays the representations of communication items with unread communication items displayed before read communication items. For example, representations 636a and 636b, shown in FIG. 6K, are displayed before representation 638a, shown in FIG. 6L.

In FIG. 6K, representations 636a and 636b are representations of communication items that are unread (e.g., as indicated by indication 611, described in greater detail above). The electronic device 500 displays representations of communication items that are unread with a preview of the content of the respective communication items and the subject of the respective communication items. For example, representation 636a includes the subject “Check in for your flight” along with a preview of the contents of the communication item. In some embodiments, displaying representations of communication items that are unread with additional information (e.g., the display of the preview of the content) is described in greater detail in method 700. Additionally, representation 636a includes selectable options 640a and 640b. Selectable option 640a, when selected, causes the electronic device 500 to display user interface 616 including the contents of the communication item associated with representation 636a. Selectable option 640b, when selected, causes the electronic device 500 to display a reply user interface 642, described in FIG. 6M, such that the user can send a reply communication item in response to the communication item corresponding to representation 636a. Representation 636b includes one or more characteristics of representation 636a. For example, representation 636b includes selectable option 640c, corresponding to option 640a, and selectable option 640d, corresponding to 640b. Selectable option 640c, when selected, causes the electronic device 500 to display user interface 616 including the contents of the communication item associated with representation 636b. Selectable option 640d, when selected, causes the electronic device 500 to display a reply user interface 642, described in FIG. 6M, such that the user can send a reply communication item in response to the communication item corresponding to representation 636b. Representation 636b also includes a preview of the contents of the communication item associated with representation 636b and the subject of the communication item (e.g., “upcoming flight”).

In FIG. 6K, the electronic device 500 receives a scroll input including contact 622b directed towards user interface 632. In response to receiving the input including contact 622b, the electronic device 500 displays additional representations (e.g., representation 638a) associated with the sender “airline 1”, as shown in FIG. 6L.

FIG. 6L illustrates the user interface 632 including representation 638a in response to the electronic device 500 receiving a scroll input to scroll down on the user interface. In response to the input including contact 622b, the header 634 does not move locations. In some embodiments, the header 634 remains at the top of the user interface 632 while the representations displayed below the header 634 move locations in response to a scroll input. Representation 638a is a representation of a communication item associated with the sender “airline 1” that has been marked as read (e.g., the electronic device 500 previously displayed the contents of the representation 638a). As such, representation 638a does not include indication 611, and a preview of the contents of the communication item. Representation 638a includes text indicating the subject of the respective communication item (e.g., “flight confirmation”). Representation 638a is also displayed below the unread representations of communication items (e.g., representations 636a and 636b). For example, the representation 638a is displayed with lower priority than representation 636a and 636b, as described in method 700.

In FIG. 6L, the electronic device 500 receives a selection input including contact 614j directed towards option 640d. In response to receiving the input including contact 614j, the electronic device 500 displays a reply user interface 642 including the contents of the communication item associated with representation 636b, shown in FIG. 6M.

In FIG. 6M, the electronic device 500 displays the reply user interface 642 including contents 651 associated with representation 636b. In response to receiving the input, the electronic device 500 also displays a second section of the user interface 642 including user interface object 654. User interface element 654 is the reply portion of the reply user interface wherein the electronic device 500 adds content (e.g., text, images, videos, or other content) to be transmitted to the sender of representation 636b. The user interface element 654 includes an indication that the electronic device 500 is replying to the sender “airline 1”, an indication of the user account (e.g., email address) that the electronic device 500 is replying from (e.g., the user account associated with “Kendra”), and an indication of the subject of the reply communication item (e.g., “re: you have an upcoming flight”). In some embodiments, the electronic device 500 receives one or more inputs directed towards keyboard 647 to add text to the user interface element 654. User interface 642 also includes selectable options 644a through 644c. Selectable option 644a, when selected, causes the electronic device 500 to cease displaying user interface 642 and resume displaying user interface 632 including the representations of communication items associated with the sender of the communication item presently being replied to. Selectable option 644b, when selected, causes the electronic device 500 to transmit the reply communication item (e.g., shown by user interface element 654) to the sender of the communication item being replied to (e.g., “Airline 1”). Selectable option 644c, when selected, causes the electronic device 500 to display a menu of additional options.

In FIG. 6M, the electronic device 500 receives a selection input including contact 614k, directed towards selectable option 644a. In response to receiving the input including contact 614k, the electronic device 500 ceases displaying user interface 642 and displays user interface 632 including the representations of communication items associated with “Airline 1”, shown in FIG. 6N.

FIG. 6N includes one or more characteristics of FIG. 6L. In FIG. 6N, the electronic device 500 receives a selection input including contact 614| directed towards selectable option 646. Selectable option 646 is similar to options 640b and 640d in that selectable option 646, when selected, causes the electronic device 500 to display the reply user interface 642. However, selectable option 646, when selected, causes the electronic device 500 to display the reply user interface 642 to reply to the most recent communication item, wherein selectable option 640b and 640d, when selected, causes the electronic device 500 to display the reply user interface 642 to reply to the communication item that the respective option is displayed over. For example, selecting the option 640b causes the electronic device 500 to display the reply user interface to reply to the communication item associated with representation 636b and not representation 636a. In response to receiving the input including contact 614l, the electronic device 500 displays user interface 642 including content 658 corresponding to the communication item corresponding to representation 636a (e.g., the most recently received communication item), as shown in FIG. 6O.

FIG. 6O illustrates the user interface 642 including content 658 from the communication item corresponding to representation 636b. Additionally, user interface 642 includes user interface element 656, which has one or more characteristics of user interface element 654 described with reference to FIG. 6M. User interface element 656 includes an indication that the electronic device 500 is replying to the sender “airline 1”, an indication of the user account (e.g., email address) that the electronic device 500 is replying from (e.g., the user account associated with “Kendra”), and an indication of the subject of the reply communication item (e.g., “re: check in for your flight”).

FIG. 6P illustrates a different embodiment of user interface 600 where the representations of communication items are not organized by category. In FIG. 6P, the electronic device 500 displays representations 648a through 648d of communication items. Representations 648a through 648d include an indication of the respective sender (e.g., text and/or a visual indication) and a preview of the content of the respective communication items. In some embodiments, the preview of the content of the respective communication item is a direct copy of a portion of the content of the respective communication item, as described in method 700. In FIG. 6P, the representations are not displayed in a conversation view, as described with reference to FIG. 6J. FIG. 6P also illustrates selectable options 650a and 650b. Option 650a, when selected, causes the electronic device 500 to display a menu including one or more categories to categorize one or more representations including representations 648a through 648d. Option 650b, when selected, causes the electronic device 500 to display a new communication item user interface where the electronic device 500 receives one or more inputs to compose a communication item to be sent to a (e.g., different) user account.

In FIG. 6P, the electronic device 500 receives a selection input including contact 614m directed towards option 650a. In response to receiving the input including contact 614m, the electronic device 500 displays the menu including categories 652a through 652g, as shown in FIG. 6Q.

FIG. 6Q illustrates the categories 652a through 652g that, when selected, causes the electronic device 500 to sort one or more representations of communication items by the respective category. In some embodiments, sorting communication items is described in greater detail in method 700. Categories 652c through 652f correspond to the categories indicated by options 604a through 604d, respectively. Additionally, the electronic device 500 is able to sort by highlighted communication items (e.g., category 652a). In some embodiments, communication items that were once highlighted and/or are currently highlighted are displayed in response to the electronic device 500 receiving an input to display highlighted communication items, as described in method 700.

In FIG. 6Q, the electronic device 500 receives a selection input including contact 614n directed towards option 652a. In response to receiving the input including contact 614n, the electronic device 500 displays representations 608a through 608g, as shown in FIG. 6R. Representations 608a through 608g are also described above with reference to FIG. 6A-6E. Representation 608a, which was no longer displayed in FIG. 6D, is redisplayed in FIG. 6R, in response to the electronic device 500 sorting the communication items by “highlights”. Redisplaying highlighted communication items is described in greater detail in method 700.

FIG. 6S illustrates an embodiment of user interface 600 discussed above. In FIG. 6S, the electronic device 500 displays representations of communication items that are part of the “primary” category of communication items. The user interface 600 includes a highlights section including highlighted communications items (e.g., representations 608a through 608b), described in greater detail above. In FIG. 6S, the options 604c and 604d include different embodiments of icons that represent the “updates” and “promotions” category, respectively, than the embodiments shown in FIG. 6A.

FIG. 6S illustrates two different inputs that result in the electronic device 500 displaying an “All Mail” category (e.g., represented by indication 604e), shown in FIG. 6T. In FIG. 6S, the electronic device 500 receives a swipe input including contact 660 (e.g., using a direct contact on touchscreen 504, such as a finger, or stylus, or an indirect contact such as a mouse curser, a gaze, a voice command, or an air gesture) directed towards the region of the user interface 600 including indications 604a through 604d. Alternatively, and as shown in FIG. 6S, the electronic device 500 receives, via the touch screen 504, a selection input including contact 6140 directed towards the indication of the category presently displayed (e.g., indication 604a). Although FIG. 6S includes multiple inputs directed towards the indications 604a through 604d, the inputs are optionally received independently. In response to either input shown in FIG. 6S, the electronic device 500 displays user interface 600, as shown in FIG. 6T, including indications of communication items from all categories, as described in method 700. In response to either input shown in FIG. 6S, the electronic device 500 also displays indication 604e to indicate that the electronic device 500 is displaying the “All Mail” view.

FIG. 6T illustrates user interface 600 including indications of communication items that are not categorized. For example, in FIG. 6T, the electronic device 500 displays representations of communication items (e.g., representations 648a through 648c) from the primary category, the transactions category, the updates category, and the promotions category, amongst other categories (e.g., rather than solely the representations of communication items from the primary category as shown in FIG. 6S). In some embodiments, the electronic device 500 displays representations of communication items in the same or similar way that they are displayed in FIG. 6P.

In FIG. 6T, the electronic device 500 displays the highlights section (e.g., including representations 608a and 608b) in addition to the indications of communication items that are not categorized. As described in method 700, the electronic device 500 displays the highlights section while in the “All Mail” view when the option to display the highlights section in the primary category is active. For example, in FIG. 6S, the electronic device 500 is displaying the highlights section, and in response to receiving the input, the electronic device 500 continues to display the highlights section while in the “All Mail” view.

In FIG. 6T, the electronic device 500 receives an input including contact 614p directed towards indication 604e (e.g., a selection of the indication 604e). In response to receiving the input, the electronic device 500 optionally ceases displaying the “All Mail” view and redisplays the previously displayed category (e.g., the primary category), as shown in FIG. 6S.

FIG. 7 is a flow diagram illustrating a method in which an electronic device displays user interfaces in a content application including categorization of indications of communication items according to some embodiments of the disclosure. The method 700 is optionally performed at first and/or electronic devices such as device 100, device 300, or device 500 as described above with reference to FIGS. 1A-1B, 2-3, 4A-4B and 5A-5C. Some operations in method 700 are, optionally combined and/or order of some operations is, optionally, changed.

As described below, the method 700 provides ways in which an electronic device displays user interfaces in a content application including categorization of indications of communication items. Displaying communication items that satisfy the one or more second criteria with a different visual appearance than communication items that don't satisfy the one or more second criteria enhances user interactions with the electronic device by reducing the number of inputs needed to identify important communication items, and also reduces erroneous inputs to the electronic device

Method 700 is performed at an electronic device in communication with a display generation component and one or more input devices, such as at electronic device 500 shown in FIG. 6A. For example, a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external). In some embodiments, the display generation component is a display integrated with the electronic device (optionally a touch screen display), external display such as a monitor, projector, television, a head-mounted display, or a hardware component (optionally integrated or external) for projecting a user interface or causing a user interface to be visible to one or more users, etc. Examples of input devices include physical buttons, knobs, handles, and/or switches of a vehicle, a touch screen, mouse (e.g., external), trackpad (optionally integrated or external), touchpad (optionally integrated or external), microphone for capturing voice commands or other audio input, remote control device (e.g., external), another electronic device (e.g., mobile device that is separate from the electronic device), a handheld device (e.g., external), a controller (e.g., external), a camera, a depth sensor, an eye tracking device, a hand tracking device, and/or a motion sensor (e.g., a hand tracking device, a hand motion sensor). In some embodiments, the hand tracking device is a wearable device, such as a smart glove. In some embodiments, the hand tracking device is a handheld input device, such as a remote control or stylus. In some embodiments, the hand tracking device is camera-based (e.g., a camera is used to determine the position of the hand).

In some embodiments, the electronic device displays (702a), via the display generation component, a content user interface including a plurality of categories of content (e.g., a content user interface of and/or associated with a content application running on the electronic device, such as a mail application, a document viewing application, a messaging application (e.g., text messaging application or other instant messaging application), a web browsing application, or a note taking application), wherein the plurality of categories (e.g., the plurality of categories includes a primary category, an updates category, a transactions category, and a promotions category) includes a first category including a first subset of respective indications of communication items of a plurality of indications (e.g., notifications) of communication items received at the electronic device (e.g., the plurality of categories also includes a second category including a second subset of respective indications of communication items of the plurality of indications of communication items), wherein the first category satisfies one or more first criteria (e.g., the first one or more criteria includes a criterion that is satisfied when the first category is a primary category), such as the categories shown by selectable options 604a through 604d. In some embodiments, the categories are associated with a same user account or multiple user accounts (e.g., email accounts) of the user of the electronic device. In some embodiments, the user displays the content user interface in response to receiving an input selecting an icon corresponding to the content application on a home screen user interface. In some embodiments, the home screen user interface serves as a “home base” for the device and had a plurality of icons associated with a plurality of applications, such as described with reference to FIG. 4A. In some embodiments, the electronic device displays the content user interface in response to receiving an input to open the content user interface within a content application. In some embodiments, the electronic device receives the plurality of notifications prior to displaying the content user interface, when displaying the content user interface, and/or at a time after first displaying the content user interface.

In some embodiments, in accordance with a determination that a first indication of a first communication item within the first category satisfies one or more second criteria including a criterion that is satisfied when the first communication item meets a highlight threshold, the electronic device displays (702c) a representation of the first indication of the first communication item with a first visual appearance in the content user interface, such as the representations 608a through 608b which are representations of indications of communication items in the first category that satisfy the one or more second criteria, shown in FIG. 6A. In some embodiments, the electronic device received the first indication from a second electronic device, different from the electronic device, such as a server, or a second mobile device. In some embodiments, the second electronic device is associated with a second user, different than the user of the electronic device. In some embodiments, the indications of communication items are transmitted from a user account of a second user. In some embodiments, the highlight threshold and/or the one or more second criteria include or correspond to an urgency, recency, and/or travel criteria. In some embodiments, satisfaction of the one or more second criteria are independent and/or from whether the first communication item is read or unread by the user of the electronic device. For example, the one or more second criteria are optionally not satisfied for a first communication item that is unread but are satisfied for a second communication item that is unread. The first communication item optionally meets the urgency criteria when the electronic device detects that there is a pending action item for the user in the first communication item (e.g., an action item requiring a response from the user of the electronic device, such as a reply to an event or meeting invitation, or a deliverable or other work product due from the user of the electronic device). In some embodiments, the first communication item meets the travel criteria when the first communication item includes information about an upcoming travel event of the user of the electronic device (e.g., a scheduled flight, train ride, bus ride, or rideshare). For example, the first communication item meets the travel criteria when the first communication item includes check-in information and/or other flight information about an upcoming flight of the user of the electronic device. In some embodiments, the first communication item meets the recency criteria when the first communication item has been received by the electronic device within a threshold amount of time, as described below. In some embodiments, the electronic device uses location data and/or data from other applications to determine whether the communication item satisfies the one or more second criteria. In some embodiments, displaying the representation of the first indication with the first visual appearance includes displaying the representation with text and/or images describing the sender of the communication item and the contents of the communication item. In some embodiments, the text describing the contents of the communication item is a summary of the contents of the communication item and not a preview of the contents of the communication item. In some embodiments, the text describing the contents also includes text describing the name and/or title of the communication item (e.g., subject line). In some embodiments, the plurality of indications includes the first subset and the second subset, different from the first subset, of respective indications of communication items. In some embodiments, representations of indications of communication items with the first visual appearance includes displaying the representations in a highlights section in the first category.

In some embodiments, in accordance with a determination that the first indication of the first communication item within the first category does not satisfy the one or more second criteria, the electronic device displays (702d) the representation of the first indication of the first communication item with a second visual appearance, different from the first visual appearance, in the content user interface, such as representations 610a and 610b which are representations of indications of communication items that do not satisfy the one or more second criteria. In some embodiments, displaying the representation with the second visual appearance includes displaying the representation with text and/or images describing the sender of the communication item and the contents of the communication item. In some embodiments, the text describing the contents of the electronic device is a preview of the text in the first communication item. In some embodiments, communication items that do not satisfy the one or more second criteria are displayed with a lower priority than communication items that do satisfy the one or more second criteria. For example, displaying with a lower priority includes displaying at a position in the user interface lower than communication items with a higher priority. In some embodiments, in response to receiving a second communication item that satisfies the one or more second criteria, the representation of the indication second communication item is displayed with the first visual appearance. Displaying communication items that satisfy the one or more second criteria with a different visual appearance than communication items that don't satisfy the one or more second criteria enhances user interactions with the electronic device by reducing the number of inputs needed to identify important communication items, and also reduces erroneous inputs to the electronic device.

In some embodiments, while displaying the content user interface including the representation of the first indication of the first communication item with the first visual appearance, the electronic device receives, via the one or more input devices, a first input corresponding to a request to display a user interface corresponding to the first communication item, such as the input including contact 614a shown in FIG. 6A. In some embodiments, the first input is or includes a selection input, such as a tap with a contact (e.g., a finger, stylus, or cursor) and/or a gaze input (optionally as part of an air gesture). In some embodiments, the first input is directed towards the representation of the first indication of the first communication item. For example, the user selects the first indication of the first communication item or a selectable option corresponding to a request to open/view the first communication item, which causes the electronic device to display the user interface corresponding to the first communication item.

In some embodiments, in response to receiving the first input, the electronic device displays, via the display generation component, the user interface corresponding to the first communication item, such as shown by user interface 616 including content 620 in FIG. 6B. In some embodiments, the user interface corresponding to the first communication item includes the content (e.g., text and/or images) associated with the first communication item. For example, if the first communication item is an email, then the user interface corresponding to the first communication item includes the contents of the email, such as text, images, and/or files associated with (e.g., attached to) the email. In some embodiments, the content in the user interface corresponding to the first communication item is different from the content displayed with the representation of the first indication of the first communication item. For example, the electronic device displays content (e.g., text and/or images) optionally synthesized by artificial intelligence and/or machine learning model(s) with the representation of the first indication of the first communication item. In some embodiments, the user interface also includes one or more selectable options to reply to, forward, delete, or save the communication item. In some embodiments, the electronic device initiates a process for transmitting a reply message to the sender of the first communication item in response to detecting an input towards the reply to option. In some embodiments, the electronic device initiates a process for transmitting the first communication item to a second user account (e.g., associated with one or more second electronic device(s) or associated with the electronic device) in response to detecting an input towards the forward option. In some embodiments, the electronic device initiates a process for deleting the first communication item in response to detecting an input towards the delete option. In some embodiments, the electronic device initiates a process for saving the first communication item in response to detecting an input towards the save option.

In some embodiments, while displaying the user interface corresponding to the first communication item, the electronic device receives, via the one or more input devices, a second input corresponding to a request to cease displaying a content application including the user interface corresponding to the first communication item, such as the input including contact 622a shown in FIG. 6B. In some embodiments, the second input includes one or more characteristics of the first input described above. In some embodiments, the second input is or includes a selection input (e.g., a tapping input or a gaze input) or a movement input (e.g., a swipe or a dragging input) to close the content application including the user interface corresponding to the first communication item. In some embodiments, the second input is directed towards a selectable option to close the content application including the user interface corresponding to the first communication item.

In some embodiments, in response to receiving the second input, the electronic device ceases the display of the content application including the user interface corresponding to the first communication item, such as shown by the display of home screen user interface 624 shown in FIG. 6C. In some embodiments, the electronic device displays a home screen user interface after the electronic device ceases the display of the user interface corresponding to the first communication item. In some embodiments, the home screen user interface serves as a “home base” for the device and has a plurality of icons associated with a plurality of applications. In some embodiments, in response to receiving the second input, the electronic device displays a different user interface of the content application (e.g., the content user interface). In some embodiments, in response to receiving the second input, the electronic device displays a user interface of a different application (e.g., such as in response to tapping a notification associated with another application or an input directed towards switching applications).

In some embodiments, after ceasing the display of the content application including the user interface corresponding to the first communication item in response to the second input, the electronic device receives, via the one or more input devices, a third input corresponding to a request to redisplay the content user interface of the content application, such as the input including contact 614b shown in FIG. 6C. In some embodiments, the third input has one or more characteristics of the first input and the second input described above.

In some embodiments, in response to receiving the third input, the electronic device redisplays the content user interface of the content application, wherein redisplaying the content user interface without displaying the representation of the first indication of the first communication item having the first visual appearance, such as no longer displaying representation 608a in FIG. 6D. In some embodiments, the electronic device reopens the content application at the content user interface. In some embodiments, in response to reopening the content user interface, the representation of the first indication of the first communication item with the first visual appearance is no longer displayed because the user had previously viewed the user interface associated with the first communication item and then closed the content application. In some embodiments, the representation of the first indication of the first communication item is displayed elsewhere (e.g., a different user interface in the content application and/or a different category in the content user interface). Forgoing displaying the representation of the first indication of the first communication item after displaying the contents of the communication item, closing the content application, and reopening the content application allows the user to view more relevant communication items that satisfy the one or more second criteria, thereby reducing erroneous inputs to the electronic device.

In some embodiments, while displaying the content user interface including the representation of the first indication of the first communication item with the first visual appearance, the electronic device receives, via the one or more input devices, a first input corresponding to a request to display a user interface corresponding to the first communication item, such the input including contact 614d shown in FIG. 6E. In some embodiments, the first input has one or more characteristics of the inputs described above. In some embodiments, the first input is directed towards the representation of the first indication of the first communication item. For example, the user selects the first indication of the first communication item or a selectable option corresponding to opening/viewing the first communication item, to display the user interface corresponding to the first communication item.

In some embodiments, in response to receiving the first input, the electronic device displays, via the display generation component, a user interface corresponding to the first communication item, such as shown by user interface 616 including content 628 shown in FIG. 6F In some embodiments, the user interface corresponding to the first communication item includes one or more characteristics of the user interface corresponding to the first communication item described above.

In some embodiments, while displaying the user interface corresponding to the first communication item, the electronic device receives, via the one or more input devices, a second input corresponding to a request to redisplay the content user interface, such as the input including contact 614e shown in FIG. 6F. In some embodiments, the second input has one or more characteristics of the inputs described above. In some embodiments, the second input is or includes a selection input directed towards a selectable option (e.g., a back button) or a movement input directed towards going to a previous user interface (e.g., the content user interface).

In some embodiments, in response to receiving the second input, the electronic device ceases displaying the user interface corresponding to the first communication item and displays the content user interface including the representation of the first indication of the first communication item with the first visual appearance, such as shown by the electronic device 500 displaying representation 608b in user interface 600 shown in FIG. 6G. In some embodiments, the content user interface includes one or more characteristics of the content user interface as described above.

In some embodiments, while displaying the content user interface after receiving the second input, the electronic device receives a third input corresponding to a request to display a second category of content in the content user interface, such as shown by input including contact 614f in FIG. 6G. In some embodiments, the third input includes one or more characteristics of the inputs described above. In some embodiments, the third input is directed towards a selectable option in the content user interface that is selectable to display a second category of communication items (e.g., display a second subset of respective indications of communication items).

In some embodiments, in response to receiving the third input, the electronic device displays the second category of content including a second subset of respective indications of communication items of the plurality of indications of communication items, such as shown by representations 630a through 630e in FIG. 6H. In some embodiments, the second subset of communication items includes different communication items than the first subset of communication items. In some embodiments, there is overlap between the communication items in the first subset and in the second subset.

In some embodiments, while displaying the second category of content, the electronic device receives a fourth input corresponding to a request to redisplay the first category of content in the content user interface, such as input including contact 614g shown in FIG. 6H.

In some embodiments, the fourth input includes one or more characteristics of the inputs described above. In some embodiments, the fourth input is a selection input directed towards a selectable option (e.g., a button) to redisplay the first category of communication items.

In some embodiments, in response to receiving the fourth input, the electronic device redisplays the first category of content including the first subset of respective indications of communication items, wherein redisplaying the first category includes redisplaying the representation of the first indication of the first communication item with the first visual appearance, such as shown by electronic device 500 continuing to display representation 608b in FIG. 6I. In some embodiments, after viewing a user interface associated with a first communication item with a first visual appearance, the electronic device continues to display the representation of the first indication of the first communication item with the first visual appearance even as the user navigates to different categories of communication items and back to the first category. In some embodiments, the electronic device stops displaying the representation of the first indication of the first communication item with the first visual appearance when the user views the user interface associated with the first communication item and closes the content application and redisplays the content user interface associated with the first category, as described above. Continuing to display the representation of the first indication of the first communication item after displaying the contents of the communication item, navigating to a different category of communication items, and navigating back to the first category allows the user to continue to view the first indication of the first communication item, thereby reducing erroneous inputs to the electronic device.

In some embodiments, the first category includes a first subset of respective indications of communication items having a first characteristic, and a second category of the plurality of categories includes a second subset of respective indications of communication items having a second characteristic, different from the first characteristic, such as the first category including a characteristic having communication items from primary senders, and the second category including a characteristic having communication items corresponding to transactions, as shown in FIG. 6A. In some embodiments, the first characteristic and the second characteristic are related to the content of the communication items. In some embodiments, the first characteristic is one of transactions content, updates content, promotions content, or important content, and the second characteristics is a different one of the aforementioned characteristics. In some embodiments, a communication item can be associated with a plurality of characteristics and as a result, the communication item is associated with and displayed with a plurality of categories. In some embodiments, the electronic device uses artificial intelligence and/or machine learning model(s) to categorize indications of communication items. Categorizing the communication items by characteristics allows the user to sort by category and view relevant communication items, thereby reducing erroneous inputs to the electronic device.

In some embodiments, the plurality of categories includes a second category (e.g., transactions category, updates category, or promotions category) including a second indication of a second communication item (e.g., having a second characteristic as described above), such as the indication represented by representation 630a shown in FIG. 6H.

In some embodiments, while displaying the content user interface including one or more representations of one or more communication items from the first category of communication items, in accordance with a determination that the second indication of the second communication item within the second category satisfies the one or more second criteria, the electronic device displays, via the display generation component, a representation of the second indication of the second communication item with the first visual appearance in the content user interface concurrently with the one or more representations of the one or more communication items from the first category of communication items, such as shown by representation 630a corresponding to representation 608f shown in FIG. 6E. In some embodiments, communication items in categories other than the first category are displayed with the first visual appearance in the first category if they satisfy the one or more second criteria. In some embodiments, the one or more second criteria include one or more characteristics of the one or more second criteria as described above. In some embodiments, the representation of the second indication of the second communication item is displayed with the first visual appearance while the electronic device displays the first subset of indication of communication items in the first category of the content user interface and also displayed with a third visual appearance, different than the first visual appearance and the second visual appearance, while the electronic device displays the second subset of indications of communication items in the second category in the content user interface. In some embodiments, the electronic device optionally displays different representation of indications of communication items with the first visual appearance, concurrently, those communication items optionally being from different categories of communication items. For example, the electronic device displays the representation of the second indication of the second communication item and the representation of the first indication of the first communication item with the first visual appearance while displaying the first category. Displaying representations of indications of communication items from other categories in the first category with the first visual appearance allows the user to view important communication items from various categories in one location, thereby reducing erroneous inputs to the electronic device.

In some embodiments, while displaying the first category in the content user interface including the representation of the first indication of the first communication item with the first visual appearance, the electronic device receives, via the one or more input devices, an input corresponding to a request to display a second category in the content user interface, such as the input including contact 614f shown in FIG. 6G to display the transactions category shown in FIG. 6H. In some embodiments, the input has one or more characteristics of the inputs described above. In some embodiments, the input is directed towards a selectable option in the content user interface that is selectable to display the second category and the indications of communication items associated with the second category.

In some embodiments, in response to receiving the input, the electronic device displays, via the display generation component, the second category including the representation of the first indication of the first communication item with a third visual appearance, different from the first visual appearance, such as representation 630a shown in FIG. 6H including a different visual appearance than the corresponding representation 608f. In some embodiments, and as described above, the first communication item has a first characteristic corresponding to the first category and a second characteristic corresponding to a different category (e.g., the second category). In some embodiments, the first communication item is displayed with the first visual appearance while the electronic device is displaying the first category and the first communication item is displayed with a third visual appearance while the electronic device is displaying the second category. For example, the first communication item is a communication item relating to checking into a flight, which would satisfy the urgency criteria in the one or more second criteria and also includes the second characteristic (e.g., a transaction) corresponding to the second category. Displaying representations of indications of communication items with the first visual appearance in other categories allows the user to view important communication items in multiple categories, thereby reducing erroneous inputs to the electronic device.

In some embodiments, the plurality of categories includes a second category including a second subset of respective indications of communication items (e.g., the second category including the characteristics of the second category as described above), such as the transactions category shown in FIG. 6H.

In some embodiments, while displaying the second category in the content user interface (e.g., including the second subset of respective indications of communication items), the electronic device displays a first visual indication corresponding to a first plurality of (and/or one or more) indications of communication items in the second subset of respective indications that is associated with a first sender, such as representation 630a corresponding to indications of communication items corresponding to the sender “airline 1”, shown in FIG. 6H. In some embodiments, a sender associated with a different user account and/or a second electronic device sends one or more communication items that have a second characteristic associated with the second category to the electronic device. In some embodiments, the electronic device groups the plurality of communication items and displays the first visual indication to represent the first one or more indications of communication items. In some embodiments, the first visual indication is selectable to display the first one or more indications of communication items. In some embodiments, the first visual indication includes text and/or images describing the first sender.

In some embodiments, while displaying the second category in the content user interface, the electronic device displays a second visual indication corresponding to second plurality of (and/or one or more) indications of communication items in the second subset of respective indications that is associated with a second sender, such as representation 630b corresponding to indications of communication items corresponding to the sender “ride share”, shown in FIG. 6H. In some embodiments, the second sender is different than the first sender. In some embodiments, the user assigns a characteristic to the first sender and/or the second sender, such that communication items from the respective sender is associated with the respective characteristic. In some embodiments, the second visual indication has one or more characteristics of the first visual indication. In some embodiments, the second visual indication includes text and/or images describing the second sender. Displaying communication items from the same sender together (e.g., using the first visual indication) allows the user to efficiently identify communication items associated with a first sender, thereby reducing erroneous inputs to the electronic device.

In some embodiments, while displaying the first visual indication and the second visual indication, the electronic device receives, via the one or more input devices, an input corresponding to a request to view the first plurality of indications of communication items in the second subset of respective indications, such as with input including contact 614i, shown in FIG. 6J. In some embodiments, the input has one or more characteristics of the inputs described above. In some embodiments, the input is directed towards the first visual indication or a selectable option corresponding to the first visual indication. In some embodiments, an input directed to the second visual indication or a selectable option corresponding to the second visual indication results in a view of the second one or more indications of communication items in the second subset of respective indications.

In some embodiments, in response to receiving the input, in accordance with a determination that a first subcategory of the first one or more communication items in the second subset of respective indications satisfies one or more third criteria (e.g., the first subcategory includes communication items that have not been read), the electronic device displays the first subcategory of the first one or more communication items in the second subset of respective indications with a third visual appearance, such as the visual appearance shown with representations 636a and 636b, shown in FIG. 6K. In some embodiments, if a communication item has not been read (e.g., a user has not viewed/opened the contents of the communication item), then the communication item is displayed with a third visual appearance. In some embodiments, the third visual appearance includes displaying a first preview of the contents of the first subcategory of communication items. In some embodiments, the third visual appearance also includes an indication on the first subset of communication items indicating that they are unread communication items. In some embodiments, the first subcategory of communication items is displayed with a higher priority than the second subcategory of communication items of the first one or more communication items. In some embodiments, displaying with higher priority includes displaying the first subcategory of communication items before the second subcategory of communication items (e.g., the location of the representation of indications of communication items that are associated with the first subcategory is higher than the location of the representation of indications of communication items associated with the second subcategory).

In some embodiments, in accordance with a determination that a second subcategory of the first one or more communication items in the second subset of respective indications does not satisfy the one or more third criteria, the electronic device displays the second subcategory of the first one or more communication items in the second subset of respective indications with a fourth visual appearance, different from the third visual appearance, such as the visual appearance shown with representation 638a, shown in FIG. 6L. In some embodiments, the second category of communication items does not satisfy the one or more third criteria when the contents of the communication items have been previously read/opened. In some embodiments, the fourth visual appearance includes a second preview of the contents of the communication item that is a shorter preview than the first preview shown with the third visual appearance. For example, the second preview includes 2 lines of content from the communication item whereas the first preview includes 4 lines of content from the communication item. In some embodiments, the indications of communication items displayed with the fourth visual appearance do not include a preview of the content while the indications of communication items displayed with the third visual appearance include a preview. In some embodiments, both displaying with the third visual appearance and the fourth visual appearance include displaying an indication of a subject, a sender, and/or a date of the respective indication of the respective communication item. In some embodiments, indications of communication items shown with a fourth visual appearance are displayed with lower priority (e.g., displayed at a location below the indication of communication items shown with the third visual appearance) than indications of communication items shown with a third visual appearance. In some embodiments, in response to receiving an input directed towards an indication of communication item displayed with the third visual appearance and/or an indication of a communication item displayed with the fourth visual appearance, the electronic device displays the user interface including the respective content associated with the respective indication of the communication item. Prioritizing unread communication items allows the user to quickly identify unread communication items, thereby reducing erroneous inputs to the electronic device.

In some embodiments, while displaying the first one or more indications of communication items in the second subset of respective indications, the electronic device receives, via the one or more input devices, a second input corresponding to a request to transmit a communication item to a sender of the first one or more indications of communication items in the second subset of respective indications, such as the input including contact 614j shown in FIG. 6L or the input including contact 614k shown in FIG. 6N. In some embodiments, the second input has one or more characteristics of the inputs as described above. In some embodiments, the second input is directed towards a first selectable option on a first indication of first communication item in the second subset of respective indications. In some embodiments, the second input is directed towards a second selectable option, different than the first selectable option, on the user interface including the first one or more indications of communication items. In some embodiments, the first selectable option is displayed overlaid on a representation of the first indication of a first communication item. In some embodiments, the first selectable option is associated with the first indication of the first communication item. In some embodiments, the second selectable option is located on the content user interface (e.g., at the bottom of the user interface). In some embodiments, the second selectable option is not associated with an indication of a communication item.

In some embodiments, in response to receiving the second input, the electronic device transmits the communication item to the sender of the first one or more indications of communication items in the second subset of respective indications. For example, in response to receiving the input including contact 614j in FIG. 6L, the electronic device 500 displays reply user interface 642 such that the user can reply to the communication item represented by representation 636b in FIG. 6M. As another example, in response to receiving the input including contact 614k in FIG. 6N, the electronic device 500 displays replay user interface 642 such that the user can reply to the most recently received communication item (e.g., indicated by representation 636a), shown in FIG. 6O. In some embodiments, in response to detecting the second input directed towards the first selectable option, the electronic device transmits the communication item to the sender of the first indication of the first communication item of the second subset, because the first selectable option is associated with the first indication of the first communication item. In some embodiments, the indications of communication items in the second subset of respective indications include respective selectable options, that when selected, causes the electronic device to transmit a communication item to the respective sender of the respective communication item. In some embodiments, in response to detecting the second input directed towards the second selectable option, the electronic device transmits the communication item to the sender of the most recent communication item of the second subset of communication items, because the second selectable option is not associated with an indication of a communication item. For example, in response to detecting the second input, the electronic device displays a reply user interface so that the user can compose a reply communication item to the respective communication item. In some embodiments, while displaying the reply user interface, the electronic device receives one or more inputs directed towards composing content of the communication items to be sent to the respective sender. For example, the electronic device receives inputs to write out a message (e.g., a typed input or voice input), insert an image, attach a file, or other message composition actions. Including selectable options to allow a user to reply to a communication item from a first sender reduces the number of inputs needed to send a reply communication item to a sender.

In some embodiments, while displaying the first visual indication corresponding to the first plurality of indications of communication items in the second subset of respective indications associated with the first sender and the second visual indication corresponding to the second plurality of indications of communication items in the second subset of respective indications associated with the second sender, the electronic device receives, via the one or more input devices, an input corresponding to a request to view the first plurality of indications of communication items in the second subset of respective indications, such as with input including contact 614i shown in FIG. 6J. In some embodiments, the input has one or more characteristics of the inputs described above. In some embodiments, the input is directed towards a selectable option (e.g., the selectable option is on or near the first visual indication). In some embodiments, the input is directed towards a second selectable option (e.g., the second selectable option is on or near the second visual indication) corresponding to a request to view the second one or more indications of communication items.

In some embodiments, in response to receiving the input, the electronic device displays information corresponding to communication items in the first plurality of indications of communication items in the second subset of respective indications, such as the information in header 634 shown in FIG. 6K. In some embodiments, the information includes a total number of communication items and a total number of unopened communication items (e.g., the user has not viewed the contents of the respective communication item) from the sender associated with the first one or more indications of communication items. In some embodiments, the information also includes an indication of the sender of the communication items (e.g., an image, icon, and/or text). Displaying information about the communication items relating to a sender while viewing a user interface including the communication items from the sender reduces the number of inputs needed to view relevant information, thereby reducing erroneous inputs to the electronic device.

In some embodiments, the plurality of categories includes a second category including a second subset of respective indications of communication items (e.g., the second category has one or more characteristics of the second category as described above. In some embodiments, the second category includes indications of communication items that do not satisfy the one or more first criteria), such as the transactions category shown in FIG. 6J.

In some embodiments, while displaying the second category, the electronic device displays the second subset of respective indications of communication items with the second visual appearance. For example, in FIG. 6J the electronic device 500 does not display representations of communication items with the first visual appearance as in the first category. In some embodiments, the electronic device does not display indications of communication items in the second category (e.g. or other categories besides the first category) with the first visual appearance. Alternatively, in some embodiments, the electronic device displays one or more indications of the second subset of respective indications of communication items that satisfies the one or more second criteria with the first visual appearance. In some embodiments, indications of communication items in the second category optionally satisfy the one or more second criteria, however, the electronic device does not display the respective indications of communications items with the first visual appearance while displaying the second category of respective indications of communication items. In some embodiments, indications of communication items in the second category that optionally satisfy the one or more second criteria are displayed in the first category with the first visual appearance. Displaying communication items that satisfy the one or more second criteria with the first visual appearance while in the first category reduces repetitive information in other categories of communication items, thereby reducing erroneous inputs to the electronic device.

In some embodiments, while displaying the content user interface, the electronic device receives, via the one or more input devices, an input corresponding to a request to customize the content user interface, such as if the electronic device receives an input directed towards a settings selectable option in user interface 600 or in a different user interface of a settings application. In some embodiments, the input has one or more characteristics of the inputs described above. In some embodiments, the input is directed towards a selectable option on the content user interface (or a different user interface of the content application) that is selectable to open a settings user interface. In some embodiments, the input is directed towards a selectable option on the home screen user interface, described above.

In some embodiments, in response to receiving the second input, the electronic device displays a settings user interface including a selectable option to control grouping of indications of communication items, such as if the electronic device 500 displays a settings user interface including an option to display the grouping as shown in FIG. 6A or to cease display the grouping, as shown in FIG. 6P. In some embodiments, the settings user interface has one or more selectable options to change one or more features of the content user interface. In some embodiments, the settings user interface includes a selectable option to cease displaying the first visual appearance, the first visual indication, and/or the second visual indication, which are described in further detail above. In some embodiments, the settings user interface also includes a selectable option to display or cease displaying the plurality of categories of communication items to control the grouping of indications of communication items. In some embodiments, if the selectable option to cease displaying the categories of indications of communication item is selected, then the electronic device displays the plurality of indications of communication items without grouping. Allowing a user to control the viewing of communication items allows the user to customize their experience with the content user interface, thereby reducing erroneous inputs to the electronic device.

In some embodiments, the content user interface includes the first category and a second category including a second subset of respective indications of communication items, and in accordance with a determination that one or more indications of the first subset of respective indications of communication items satisfies one or more third criteria (e.g., the contents of the one or more communication item have not been viewed by the user (e.g., the electronic device has not received an input corresponding to a request to display the respective contents of the one or more communication items)), the electronic device displays, via the display generation component, the one or more indications of the first subset of respective indications of communication items with a third visual appearance in the content user interface overlaid on an indication of the first category, such as indication 606a overlaid over option 604a shown in FIG. 6A. In some embodiments, the third visual appearance includes a display of a dot and/or number next to the indication of the first category to indicate the number of indications of communication items that have satisfied the one or more third criteria. In some embodiments, the electronic device displays the indication of the first category at the top of the content user interface. In some embodiments, the indication of the first category includes text and/or images corresponding to the first category.

In some embodiments, in accordance with a determination that one or more indications of the second subset of respective indications of communication items satisfies one or more third criteria, the electronic device displays, via the display generation component, the one or more indications of the second subset of the respective indications of communication items with a fourth visual appearance, different than the third visual appearance in the content user interface overlaid on an indication of the second category, such as indication 606b overlaid over option 604b shown in FIG. 6A. In some embodiments, the electronic device displays the indication of the second category at the top of the content user interface, adjacent or near the indication of the first category. In some embodiments, the indication of the second category includes text and/or images corresponding to the second category. In some embodiments, the fourth visual appearance serves the same purpose as the third visual appearance (e.g., to indicate the number of indications of communication items that satisfy the one or more third criteria), however, the electronic device displays the third visual appearance on the indication of the first category and the fourth visual appearance on the indication of the second category. In some embodiments, the third visual appearance and the fourth visual appearance are separately controlled (e.g., changing the number representation on one of the visual indication does not affect the other visual appearance). In some embodiments, indications of communication items are in two categories (e.g., the first category and the second category). In some embodiments, display the contents of the respective indication of the respective communication item causes the respective indication of the respective communication to no longer satisfy the one or more third criteria, and both the third visual appearance and the fourth visual appearance are updated (e.g., since the respective indication of the respective communication item is in the first category and the second category). Including different visual appearances to indicate unread communication items in different categories enhances user interactions with the electronic device by allowing the user to easily identify unread communication items in different categories, thereby reducing erroneous inputs to the electronic device.

In some embodiments, displaying the content user interface including the plurality of categories of content includes displaying communication items of a plurality of (and/or one or more) user accounts associated with a user of the electronic device, such as if user interface 600 includes indications of communication items from a plurality of email addresses in FIG. 6A. For example, the electronic device displays communication items from one or more email addresses of the user in the content user interface. In some embodiments, the first category including the first subset of respective indications of communication items includes indications of communication items from a first user account and a second user account (e.g., a first email address and a second email address or a first phone number and a second phone number). In some embodiments, the electronic device displays communication items corresponding to a first user account in response to detecting an input directed towards a selectable option in the settings user interface, described above. In some embodiments, the electronic device displays indications of communication items that satisfy the one or more second criteria from the first user account and the second user account (and optionally other user accounts) with the first visual appearance. Displaying communication items from multiple user accounts allows the user to view communication items from multiple user accounts together, thereby reducing the number of inputs needed to identify important communication items in multiple user accounts.

In some embodiments, while displaying a plurality of categories of content including the first category and a second category on the content user interface (e.g., while displaying the plurality of indications of communication items including the first subset and the second subset), such as shown by representations 648a through 648d in FIG. 6P, the electronic device receives, via the one or more input devices, an input corresponding to a request to display the first category, different from the second category, such as with input including 614n in FIG. 6Q. In some embodiments, the input has one or more characteristics of the inputs described above. In some embodiments, the input is a selection input directed towards a selectable option on the content user interface that is selectable to navigate between categories of indications of communication items. In some embodiments, the content user interface includes a menu of selectable options that are selectable to filter by a specified category. For example, the menu includes a selectable option to display the first subset of respective indications, a selectable option to display the second subset of respective indications, and a selectable option to display indications that satisfy (or previously satisfy) the one or more second criteria.

In some embodiments, in response to receiving the input, the electronic device ceases displaying the second subset of respective indications of communication items of the second category on the content user interface and displays the first subset of respective indications of communication items associated with the first category on a second content user interface (e.g., the electronic device navigates to a different user interface including the second category), such as displaying representations 608a through 608g shown in FIG. 6R. In some embodiments, the categories include a respective user interface and in response to the input, the electronic device navigates to a respective user interface of the respective category. In some embodiments, the electronic device is displaying the plurality of respective indications of communication items including the first subset and the second subset, and in response to receiving the input, the electronic device displays the respective subset of indications of communication items. In some embodiments, while displaying the second subset of respective indications of communication items, the electronic device receives an input directed towards the selectable option, and in response, the electronic device displays the first subset. In some embodiments, the user can navigate between categories using the selectable option. Including a selectable option to filter by category allows the user to efficiently filter communication items by categories, thereby reducing erroneous inputs to the electronic device.

In some embodiments, while displaying the content user interface including the first indication of the first communication item that satisfies the one or more second criteria with the first visual appearance, the electronic device receives, via the one or more input devices, an input corresponding to a request to filter the first subset of respective indications of communication items based on one or more third criteria, such as if the electronic device 500 receives an input directed towards a selectable option similar to option 652b shown in FIG. 6Q while in FIG. 6A. In some embodiments, the input has one or more characteristics of the inputs described above. In some embodiments, the one or more third criteria have one or more characteristics of the one or more third criteria as described above. In some embodiments, the one or more third criteria are satisfied when the electronic device has not previously displayed the contents of the respective communication item. In some embodiments, the input is directed towards a selectable option on the content user interface or on a settings user interface (described above).

In some embodiments, in response to receiving the input, the electronic device displays, via the display generation component, one or more indications of one or more communication items that satisfy the one or more third criteria. In accordance with a determination that the first communication item satisfies the one or more third criteria, the electronic device displays the first indication of the first communication item with a first priority relative to others of the one or more indications of the one or more communication items and with the first visual indication, such as if the electronic device displays the indications of communication items that satisfy the one or more third criteria in user interface 600. In some embodiments, communication items that satisfy the one or more second criteria and the one or more third criteria are displayed with higher priority than communication items that satisfy only one of the aforementioned one or more criteria. In some embodiments, the first priority is a higher priority than the second priority, described below. In some embodiments, displaying the first indication of the first communication item with the first priority includes displaying the first indication at a location higher on the user interface than communication items with the second priority. In some embodiments, the priority of a communication item is independent of the time that the communication item was received by the electronic device. For example, an older communication item that satisfies the one or more third criteria is displayed with higher priority (e.g., the first priority) than a more recently received communication item that does not satisfy the one or more third criteria. For example, the first indication is displayed before a second indication that does not satisfy the one or more third criteria. In some embodiments, displaying the first indication of the first communication item with the first priority includes displaying the first indication with a third visual appearance, such as the third visual appearance described above.

In some embodiments, in accordance with a determination that the first communication item does not satisfy the one or more third criteria, the electronic device ceases displaying the indication of the first communication item, such as if the electronic device forgoes displaying the indications of communication items that do not satisfy the one or more third criteria in user interface 600. In some embodiments, the electronic device displays the indications of communication items that satisfy the one or more third criteria without displaying indications of communication item that do not satisfy the one or more third criteria. Alternatively, in some embodiments, the electronic device displays the indication of the first communication item with a second priority, lower than the first priority, relative to the others of the one or more indications of the one or more communication items and with the first visual indication. In some embodiments, displaying the indication of the first communication item with the second priority also includes displaying the indication of the first communication item with the third visual appearance. In some embodiments, a third indication of a third communication item is displayed with the second visual indication (e.g., communication items that don't satisfy the one or more second criteria) and also satisfies the one or more third criteria. In some embodiments, the third indication has a third priority, lower than the second priority, and is displayed below the indications of communication items with the second priority. In some embodiments, indications of communication items that don't satisfy the one or more second criteria or the one or more third criteria are displayed with a fourth priority, lower than the third priority. Maintaining the first visual indication while filtering by unread messages allows a user to efficiently identify important unread messages, thereby reducing erroneous inputs to the electronic device.

In some embodiments, the representation of the first indication of the first communication item that is displayed with the first visual appearance is displayed with a higher priority (e.g., the highlights section including the representations of indications of communication items with the first visual appearance, as described above, is displayed with higher priority) within the content user interface than a second indication of a second communication item (e.g., from the first category and/or from a second category that is also displayed in the first category) that is displayed with the second visual appearance, such as representations 608a through 608c being displayed before representations 610a and 610b shown in FIG. 6A. In some embodiments, the indications of communication items that satisfy the one or more second criteria are displayed with a higher priority than indications of communication items that do not satisfy the one or more second criteria. In some embodiments, displaying indications of communication items with the higher priority includes displaying the indications of communication items that satisfy the one or more second criteria before the indications of communication items that do not satisfy the one or more second criteria. In some embodiments, displaying with the higher priority includes displaying the indications of communication items that satisfy the one or more second criteria in a different (e.g., separate) section of the content user interface from the indications of communication items that don't satisfy the one or more second criteria. Displaying communication items that satisfy the one or more second criteria with a higher priority than communication items that don't satisfy the one or more second criteria enhances user interactions with the electronic device by reducing the number of inputs needed to identify important communication items, and also reduces erroneous inputs to the electronic device.

In some embodiments, while displaying the representation of the first indication of the first communication item with the first visual appearance, the electronic device receives, via the one or more input devices, an input corresponding to a request to view additional indications of additional communication items in the first category that satisfy the one or more second criteria, such as with input including contact 614c in FIG. 6D. In some embodiments, the input has one or more characteristics of the inputs described above. In some embodiments, the input is directed towards a selectable option on the content user interface.

In some embodiments, in response to receiving the input, the electronic device displays the representations of additional indications of additional communication items in the first category with the first visual appearance (e.g., including displaying the representation of the first indication of the first communication item in the additional indications), such as displaying representations 608a through 608h in FIG. 6E. In some embodiments, the electronic device ceases displaying the indication of communication items with the second visual appearance in response to receiving the input. In some embodiments, the electronic device displays a second user interface including the representations of the additional indications of additional communication items. In some embodiments, the representations of additional indications of additional communication items were not previously displayed in the user interface before receiving the input. Including a selectable option that is selectable to display additional important communication items enhances user interactions with the electronic device by reducing the number of inputs needed to identify important communication items, and also reduces erroneous inputs to the electronic device.

In some embodiments, while displaying the content user interface including the first indication of the first communication item that satisfies the one or more second criteria with the first visual indication, the electronic device determines that the first indication of the first communication item satisfies one or more third criteria, such as the electronic device 500 displaying the contents of representation 608a and then receiving an input to close the content application and then reopen the content application, as described above and shown in FIGS. 6A-6D. In some embodiments, the first indication of the first communication item satisfies the one or more third criteria after the electronic device redisplays the content user interface after displaying the contents of the first communication item and in response to receiving an input to cease displaying the content user interface. In some embodiments, the first indication of the first communication item satisfies the one or more third criteria when the first indication of the first communication item ceases to satisfy the one or more second criteria. For example, the first indication of the first communication item no longer satisfies the urgency, recency, and/or travel criteria described above.

In some embodiments, in response to determining that the first indication of the first communication item satisfies the one or more third criteria, the electronic device ceases displaying the first indication of the first communication item with the first visual appearance and assigning a first attribute to the first communication item, such as no longer displaying representation 608a in FIG. 6D. In some embodiments, ceasing displaying the first indication of the first communication item with the first visual appearance also includes displaying the first indication with the second visual appearance. In some embodiments, communication items that satisfy (and/or originally satisfied) the second one or more criteria are assigned a first attribute even if they no longer satisfy the one or more second criteria (e.g., after they are read or consumed). In some embodiments, the first attribute is part of the metadata associated with the first communication item. In some embodiments, assigning the first attribute does not include displaying a visual indication associated with the first attribute. Alternatively, in some embodiments, assigning the first attribute includes displaying a visual indication (e.g., an icon) associated with the first attribute on the first indication of the first communication item.

In some embodiments, while displaying the representation of the first indication of the first communication item without the first visual appearance (e.g., while the first communication item does not satisfy the one or more second criteria and while the representation of the first indication of the first communication item is not displayed in the highlights section), the electronic device receives, via the one or more input devices, an input corresponding to a request to filter the first subset of respective indications of communication items according to the first attribute, such as input including contact 614n in FIG. 6Q. In some embodiments, the input has one or more characteristics of the inputs described above. In some embodiments, the input is directed towards a selectable option on the content user interface.

In some embodiments, in response to receiving the input, the electronic device displays, in the content user interface, the representation of the first indication of the first communication item with the first attribute, such as displaying representation 608a in FIG. 6R that was not previously displayed in FIG. 6D. In some embodiments, in response to receiving the input, the electronic device forgoes displaying the representations of one or more indications of communication items that are not assigned the first attribute, such as representation 608c, shown in FIG. 6P, which is not currently or previously a highlighted communication item. In some embodiments, in response to receiving the input, the electronic device displays the indications of communication items that previously or currently satisfies the one or more second criteria (e.g., the results of the operations here include displaying communication items that were previously highlights but are not currently highlights). Alternatively, in some embodiments, the electronic device displays the indications of communication items with the first attribute with a higher priority (e.g., displaying with a higher priority is described above) including displaying them before the indications of communication items that are not assigned the first attribute. In some embodiments, a representation of a second indication of a second communication is displayed with the first visual appearance before the electronic device receives the input corresponding to the request to filter the first subset of the respective indications of communication items according to the first attribute. In some embodiments, in response to receiving the input, the electronic device displays the representation of the second indication of the second communication item with the first attribute, as well as, displaying the representation of the first indication of the first communication item with the first attribute. Associating communication items that currently or previously satisfy the one or more second criteria with the first attribute enhances user interactions with the electronic device by reducing the number of inputs needed to identify previously or presently important communication items, and also reduces erroneous inputs to the electronic device.

In some embodiments, in accordance with a determination that the representation of the first indication of the first communication item satisfies the one or more second criteria, the electronic device displays the representation of the first indication of the first communication item with the first visual appearance includes displaying a synthesized summary of the communication item, such as the text shown in representation 608a in FIG. 6A. In some embodiments, the electronic device creates the synthesized summary of the communication item using one or more artificial intelligence methods and/or machine learning models. In some embodiments, the synthesized summary of the communication item summarizes the contents of the communication item. In some embodiments, the synthesized summary does not include parallel content in the contents of the communication item (e.g., the synthesized summary is not a direct copy of (a portion or all of) the text and/or images in the contents of the communication item). For example, the synthesized summary is not word for word in the contents of the communication item.

In some embodiments, in accordance with a determination that the representation of the first indication of the first communication item does not satisfy the one or more second criteria, the electronic device displays the representation of the first indication of the first communication item with the second visual appearance includes displaying a portion of the content of the communication item, such as the text shown in representation 610b in FIG. 6A. In some embodiments, displaying the portion of the content includes displaying a first sentence, a first 10 words, a first 20 words, or a first 50 words of the content of the communication item. In some embodiments, displaying the portion of the content of the communication item is different than displaying the synthesized summary as described above. In some embodiments, the portion of the content exists in the content of the communication item and is a direct copy of a portion of the text and/or images in the contents of the communication item. For example, the portion of the content of the communication item is word for word in the content of the communication item. Displaying communication items that satisfy the one or more second criteria with a synthesized summary of the contents of the communication item enhances user interactions with the electronic device by reducing the number of inputs needed to identify important communication items, and also reduces erroneous inputs to the electronic device.

In some embodiments, while displaying the representation of the first indication of the first communication item, the electronic device receives, via the one or more input devices, an input corresponding to a request to select the first communication item, such as input including contact 614a in FIG. 6A. In some embodiments, the input has one or more characteristics of the inputs described above. In some embodiments, the input is directed towards the representation of the indication of the communication item.

In some embodiments, in response to receiving the input, in accordance with a determination that the representation of the first indication of the first communication item is displayed with the first visual appearance when the input is received, the electronic device displays, via the display generation component, content of the first communication item, such as shown with content 620 in FIG. 6B.

In some embodiments, in response to receiving the input, in accordance with a determination that the representation of the first indication of the first communication item is displayed with the second visual appearance when the input is received, the electronic device displays the content of the first communication item, such as if the content 620 shown in FIG. 6B was associated with a representation that is not a highlighted representation (e.g., representation 610b). In some embodiments, regardless of the visual appearance associated with the communication item, in response to receiving the input, the electronic device displays the contents of the communication item. For example, if the representation of the indication of the first communication item is displayed with the first visual appearance when the input is received, then in response to the input, the electronic device displays the contents of the communication item. If the representation of the indication of the first communication item is displayed with the second visual appearance when the input is received, then in response to the input, the electronic device also displays the same contents of the communication item. Alternatively, in some embodiments, the input results in a display of different contents based on whether the communication item satisfies the one or more second criteria discussed above. Displaying the contents of the communication item in response to detecting an input directed at the representation of the communication item enhances user interactions with the electronic device by reducing the number of inputs needed to view the contents of a communication item, and also reduces erroneous inputs to the electronic device.

In some embodiments, while displaying a category in the content user interface (e.g., the first category in the content user interface including the representation of the first indication of the first communication item with the first visual appearance, or while displaying a second category or a different category), the electronic device receives, via the one or more input devices, an input corresponding to a request to display the plurality of indications of communication items received at the electronic device independent of category, such as inputs with contact 6140 and 660 shown in FIG. 6S. In some embodiments, the input is described in greater detail below. In some embodiments, the request is a request to display the plurality of indications of communication items as uncategorized (e.g., independent of the current category displayed in the content user interface).

In some embodiments, in response to receiving the input, the electronic device displays, via the one or more input devices, the plurality of indications of communication items (e.g., from a plurality of categories) in the content user interface independent of category, such as representations 648a through 648c shown in FIG. 6T. In some embodiments, if the electronic device was previously displaying the highlights section, described in greater detail above, while displaying the first category, then the electronic device continues to display the highlights section (e.g., including the representations of communication items that satisfy the one or more second criteria). In some embodiments, the electronic device displays the highlights section while displaying the plurality of indications of communication items in the content user interface irrespective of what category of indications of communication items were previously displayed (e.g., when the input was received). In some embodiments, the electronic device optionally provides an option to turn on and off the display of the highlights section. In some embodiments, if the option to turn on the highlights section is activated, then the electronic device displays the highlights section while displaying the first category (e.g., the primary category) and also displays the highlights section while displaying the plurality of indications of communication items. In some embodiments, the electronic device displays the highlights section before displaying the plurality of communication items in the content user interface. In some embodiments, if the electronic device was not previously displaying the first category with the highlights section and/or the option to turn off the highlights section is activated, then the electronic device does not display the highlights section while displaying the plurality of indications of communication items in the content user interface. In some embodiments, prior to receiving the input, the electronic device displays a plurality of indications corresponding to different categories of communication items without displaying an indication corresponding to an “all communication items” category (e.g., an unsorted view). In some embodiments, in response to receiving the input, the electronic device displays the plurality of indications of communication items and the indication corresponding to the “all communication items” category. Including a category that includes a view of all communication items enhances user interactions with the electronic device by reducing the number of inputs needed to view all communication items, unsorted, and also reduces erroneous inputs to the electronic device.

In some embodiments, the input includes a swipe input directed towards one or more indications corresponding to the plurality of categories of content, such as input 660 shown in FIG. 6S that includes swiping across (e.g., from right to left) the options 604a through 604d. In some embodiments, the swipe input is or includes a tap and drag input using a finger or a stylus (e.g., on a touch-sensitive surface of the input devices, such as a touchscreen or touchpad). In some embodiments, the swipe input is received using an air gesture (e.g., an air-pinch and drag), a gaze gesture, a tap and drag using a mouse, or a voice command. In some embodiments, the swipe input is a right to left swipe directed towards the indications. In some embodiments, the swipe input is only in one direction (e.g., the view won't switch to the unsorted view in response to a left to right swipe input). Displaying the unsorted view in response to receiving a swipe input enhances user interactions with the electronic device by reducing the number of inputs needed to view all communication items, unsorted, and also reduces erroneous inputs to the electronic device.

In some embodiments, the input includes a selection input directed towards an indication of the category (e.g., the category that the electronic device was displaying before displaying the plurality of indications of communication items such as the first category or the second category) in the content user interface, such as input including contact 6140 shown in FIG. 6S directed towards selecting option 604a. In some embodiments, the selection input is or includes a tap input, air gesture, a click input, and/or a gaze input. In some embodiments, the tap input includes an input using a finger or a stylus (e.g., on a touch-sensitive surface of the input devices, such as a touchscreen or touchpad). In some embodiments, the selection input is a voice command to select the indication of the respective category. In some embodiments, in response to receiving the input, the electronic device displays an indication of the unsorted view concurrently with the plurality of indications of communication items in the content user interface. In some embodiments, in response to receiving an input directed towards the indication of the unsorted view (e.g., while displaying the plurality of indications of communication items in the content user interface), such as a selection input directed to the indication of the unsorted view, the electronic device ceases displaying the plurality of indications of communication items, and redisplays the subset of indications of communication items of the previously displayed category (e.g., the first category or the second category discussed above). In some embodiments, while displaying a category in the content user interface, if the electronic device receives a selection input directed towards an indication of a different category, then the electronic device displays the one or more indications of communication items corresponding to that respective category instead of the unsorted view. Displaying the unsorted view in response to receiving a tap input enhances user interactions with the electronic device by reducing the number of inputs needed to view all communication items, unsorted, and also reduces erroneous inputs to the electronic device.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., a as described with respect to FIGS. 1A-1B, 3, 5A-5J) or application specific chips. Further, the operations described above with reference to FIG. 7 is, optionally, implemented by components depicted in FIGS. 1A-1B. For example, displaying operation 702a, 702b, and 702c are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is tracking and displaying content. The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, capturing and transmitting communication items can enable the user to view the content of the communication item at a later time. Accordingly, use of such personal information data enables users to use electronic devices to view content. Further, other uses for personal information data that benefit the user are also contemplated by the present disclosure. For instance, personal information data may be used to categorize communication items.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device version tracks communication items without associating the communication items with personal user data.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device in communication with a display generation component and one or more input devices:
displaying, via the display generation component, a content user interface including a plurality of categories of content, wherein the plurality of categories includes a first category including a first subset of respective indications of communication items of a plurality of indications of communication items received at the electronic device, wherein the first category satisfies one or more first criteria, including:
in accordance with a determination that a first indication of a first communication item within the first category satisfies one or more second criteria including a criterion that is satisfied when the first communication item meets a highlight threshold, displaying a representation of the first indication of the first communication item with a first visual appearance in the content user interface; and
in accordance with a determination that the first indication of the first communication item within the first category does not satisfy the one or more second criteria, displaying the representation of the first indication of the first communication item with a second visual appearance, different from the first visual appearance, in the content user interface.

2. The method of claim 1, further comprising:
while displaying the content user interface including the representation of the first indication of the first communication item with the first visual appearance, receiving, via the one or more input devices, a first input corresponding to a request to display a user interface corresponding to the first communication item;
in response to receiving the first input, displaying, via the display generation component, the user interface corresponding to the first communication item;
while displaying the user interface corresponding to the first communication item, receiving, via the one or more input devices, a second input corresponding to a request to cease displaying a content application including the user interface corresponding to the first communication item;
in response to receiving the second input, ceasing the display of the content application including the user interface corresponding to the first communication item;
after ceasing the display of the content application including the user interface corresponding to the first communication item in response to the second input:
receiving, via the one or more input devices, a third input corresponding to a request to redisplay the content user interface of the content application; and
in response to receiving the third input, redisplaying the content user interface of the content application, wherein redisplaying the content user interface without displaying the representation of the first indication of the first communication item having the first visual appearance.

3. The method of claim 1, further comprising:
while displaying the content user interface including the representation of the first indication of the first communication item with the first visual appearance, receiving, via the one or more input devices, a first input corresponding to a request to display a user interface corresponding to the first communication item;
in response to receiving the first input, displaying, via the display generation component, a user interface corresponding to the first communication item;
while displaying the user interface corresponding to the first communication item, receiving, via the one or more input devices, a second input corresponding to a request to redisplay the content user interface;
in response to receiving the second input:
ceasing displaying the user interface corresponding to the first communication item; and
displaying the content user interface including the representation of the first indication of the first communication item with the first visual appearance;
while displaying the content user interface after receiving the second input, receiving a third input corresponding to a request to display a second category of content in the content user interface;
in response to receiving the third input, displaying the second category of content including a second subset of respective indications of communication items of the plurality of indications of communication items;
while displaying the second category of content, receiving a fourth input corresponding to a request to redisplay the first category of content in the content user interface;
in response to receiving the fourth input, redisplaying the first category of content including the first subset of respective indications of communication items, wherein redisplaying the first category includes redisplaying the representation of the first indication of the first communication item with the first visual appearance.

4. The method of claim 1, wherein the first category includes a first subset of respective indications of communication items having a first characteristic, and a second category of the plurality of categories includes a second subset of respective indications of communication items having a second characteristic, different from the first characteristic.

5. The method of claim 1, wherein the plurality of categories includes a second category including a second indication of a second communication item,
the method further comprising:
while displaying the content user interface including one or more representations of one or more communication items from the first category of communication items:
in accordance with a determination that the second indication of the second communication item within the second category satisfies the one or more second criteria, displaying, via the display generation component, a representation of the second indication of the second communication item with the first visual appearance in the content user interface concurrently with the one or more representations of the one or more communication items from the first category of communication items.

6. The method of claim 1, further comprising:
while displaying the first category in the content user interface including the representation of the first indication of the first communication item with the first visual appearance, receiving, via the one or more input devices, an input corresponding to a request to display a second category in the content user interface; and
in response to receiving the input, displaying, via the display generation component, the second category including the representation of the first indication of the first communication item with a third visual appearance, different from the first visual appearance.

7. The method of claim 1, wherein the plurality of categories includes a second category including a second subset of respective indications of communication items, the method further comprising:
while displaying the second category in the content user interface:
displaying a first visual indication corresponding to a first plurality of indications of communication items in the second subset of respective indications that is associated with a first sender; and
displaying a second visual indication corresponding to second plurality of indications of communication items in the second subset of respective indications that is associated with a second sender.

8. The method of claim 7, further comprising:
while displaying the first visual indication and the second visual indication, receiving, via the one or more input devices, an input corresponding to a request to view the first plurality of indications of communication items in the second subset of respective indications; and
in response to receiving the input:
in accordance with a determination that a first subcategory of the first one or more communication items in the second subset of respective indications satisfies one or more third criteria, displaying the first subcategory of the first one or more communication items in the second subset of respective indications with a third visual appearance; and
in accordance with a determination that a second subcategory of the first one or more communication items in the second subset of respective indications does not satisfy the one or more third criteria, displaying the second subcategory of the first one or more communication items in the second subset of respective indications with a fourth visual appearance, different from the third visual appearance.

9. The method of claim 8, further comprising:
while displaying the first one or more indications of communication items in the second subset of respective indications, receiving, via the one or more input devices, a second input corresponding to a request to transmit a communication item to a sender of the first one or more indications of communication items in the second subset of respective indications; and
in response to receiving the second input:
transmitting the communication item to the sender of the first one or more indications of communication items in the second subset of respective indications.

10. The method of claim 7, further comprising:
while displaying the first visual indication corresponding to the first plurality of indications of communication items in the second subset of respective indications associated with the first sender and the second visual indication corresponding to the second plurality of indications of communication items in the second subset of respective indications associated with the second sender, receiving, via the one or more input devices, an input corresponding to a request to view the first plurality of indications of communication items in the second subset of respective indications; and
in response to receiving the input:
displaying information corresponding to communication items in the first plurality of indications of communication items in the second subset of respective indications.

11. The method of claim 1, wherein the plurality of categories includes a second category including a second subset of respective indications of communication items, the method further comprising:
displaying the second subset of respective indications of communication items with the second visual appearance.

12. The method of claim 1, further comprising:
while displaying the content user interface, receiving, via the one or more input devices, an input corresponding to a request to customize the content user interface; and
in response to receiving the second input, displaying a settings user interface including a selectable option to control grouping of indications of communication items.

13. The method of claim 1, wherein the content user interface includes the first category and a second category including a second subset of respective indications of communication items, the method further comprising:
in accordance with a determination that one or more indications of the first subset of respective indications of communication items satisfies one or more third criteria, displaying, via the display generation component, the one or more indications of the first subset of respective indications of communication items with a third visual appearance in the content user interface overlaid on an indication of the first category; and
in accordance with a determination that one or more indications of the second subset of respective indications of communication items satisfies one or more third criteria, displaying, via the display generation component, the one or more indications of the second subset of the respective indications of communication items with a fourth visual appearance, different than the third visual appearance in the content user interface overlaid on an indication of the second category.

14. The method of claim 1, wherein displaying the content user interface including the plurality of categories of content includes displaying communication items of a plurality of user accounts associated with a user of the electronic device.

15. The method of claim 1, wherein displaying the content user interface including the plurality of categories of content further comprises:
while displaying a plurality of categories of content including the first category and a second category on the content user interface, receiving, via the one or more input devices, an input corresponding to a request to display the first category, different from the second category; and
in response to receiving the input:
ceasing displaying a second subset of respective indications of communication items of the second category on the content user interface; and
displaying the first subset of respective indications of communication items associated with the first category on a second content user interface.

16. The method of claim 1, further comprising:
while displaying the content user interface including the first indication of the first communication item that satisfies the one or more second criteria with the first visual appearance, receiving, via the one or more input devices, an input corresponding to a request to filter the first subset of respective indications of communication items based on one or more third criteria; and
in response to receiving the input:
displaying, via the display generation component, one or more indications of one or more communication items that satisfy the one or more third criteria, including:
in accordance with a determination that the first communication item satisfies the one or more third criteria, displaying the first indication of the first communication item with a first priority relative to others of the one or more indications of the one or more communication items and with the first visual appearance; and
in accordance with a determination that the first communication item does not satisfy the one or more third criteria, ceasing displaying the indication of the first communication item.

17. The method of claim 1, wherein the representation of the first indication of the first communication item that is displayed with the first visual appearance is displayed with a higher priority within the content user interface than a second indication of a second communication item that is displayed with the second visual appearance.

18. The method of claim 1, further comprising:
while displaying the representation of the first indication of the first communication item with the first visual appearance, receiving, via the one or more input devices, an input corresponding to a request to view additional indications of additional communication items in the first category that satisfy the one or more second criteria; and
in response to receiving the input, displaying the representations of additional indications of additional communication items in the first category with the first visual appearance.

19. The method of claim 1, further comprising:
while displaying the content user interface including the first indication of the first communication item that satisfies the one or more second criteria with the first visual appearance, determining that the first indication of the first communication item satisfies one or more third criteria;
in response to determining that the first indication of the first communication item satisfies the one or more third criteria, ceasing displaying the first indication of the first communication item with the first visual appearance and assigning a first attribute to the first communication item;
while displaying the representation of the first indication of the first communication item without the first visual appearance, receiving, via the one or more input devices, an input corresponding to a request to filter the first subset of respective indications of communication items according to the first attribute; and
in response to receiving the input:
displaying, in the content user interface, the representation of the first indication of the first communication item with the first attribute; and
forgoing displaying the representations of one or more indications of communication items that are not assigned the first attribute.

20. The method of claim 1, wherein:
in accordance with a determination that the representation of the first indication of the first communication item satisfies the one or more second criteria, displaying the representation of the first indication of the first communication item with the first visual appearance includes displaying a synthesized summary of the first communication item; and
in accordance with a determination that the representation of the first indication of the first communication item does not satisfy the one or more second criteria, displaying the representation of the first indication of the first communication item with the second visual appearance includes displaying a portion of the content of the first communication item.

21. The method of claim 1, further comprising:
while displaying the representation of the first indication of the first communication item, receiving, via the one or more input devices, an input corresponding to a request to select the first communication item; and
in response to receiving the input:
in accordance with a determination that the representation of the first indication of the first communication item is displayed with the first visual appearance when the input is received, displaying, via the display generation component, content of the first communication item; and
in accordance with a determination that the representation of the first indication of the first communication item is displayed with the second visual appearance when the input is received, displaying the content of the first communication item.

22. The method of claim 1, further comprising:
while displaying a category in the content user interface, receiving, via the one or more input devices, an input corresponding to a request to display the plurality of indications of communication items received at the electronic device independent of category; and
in response to receiving the input, displaying, via the one or more input devices, the plurality of indications of communication items in the content user interface independent of category.

23. The method of claim 22, wherein the input includes a swipe input directed towards one or more indications corresponding to the plurality of categories of content.

24. The method of claim 22, wherein the input includes a selection input directed towards an indication of the category in the content user interface.

25. An electronic device that is in communication with a display generation component and one or more input devices, the electronic device comprising:
one or more processors;
memory; and
one or more programs, wherein the one or more programs are stored in the memory and configured to be executed by the one or more processors, the one or more programs including instructions for:
displaying, via the display generation component, a content user interface including a plurality of categories of content, wherein the plurality of categories includes a first category including a first subset of respective indications of communication items of a plurality of indications of communication items received at the electronic device, wherein the first category satisfies one or more first criteria, including:
in accordance with a determination that a first indication of a first communication item within the first category satisfies one or more second criteria including a criterion that is satisfied when the first communication item meets a highlight threshold, displaying a representation of the first indication of the first communication item with a first visual appearance in the content user interface; and
in accordance with a determination that the first indication of the first communication item within the first category does not satisfy the one or more second criteria, displaying the representation of the first indication of the first communication item with a second visual appearance, different from the first visual appearance, in the content user interface.

26. A non-transitory computer readable storage medium storing one or more programs, the one or more programs comprising instructions, which when executed by one or more processors of an electronic device, cause the electronic device to perform a method comprising:
displaying, via a display generation component, a content user interface including a plurality of categories of content, wherein the plurality of categories includes a first category including a first subset of respective indications of communication items of a plurality of indications of communication items received at the electronic device, wherein the first category satisfies one or more first criteria, including:
in accordance with a determination that a first indication of a first communication item within the first category satisfies one or more second criteria including a criterion that is satisfied when the first communication item meets a highlight threshold, displaying a representation of the first indication of the first communication item with a first visual appearance in the content user interface; and
in accordance with a determination that the first indication of the first communication item within the first category does not satisfy the one or more second criteria, displaying the representation of the first indication of the first communication item with a second visual appearance, different from the first visual appearance, in the content user interface.
